(19) United States
(12) Patent Application Publication
(10) Pub. No.: US 2018/0196506 A1
(43) Pub. Date: Jul. 12, 2018

(54) INFORMATION PROCESSING METHOD AND APPARATUS, INFORMATION PROCESSING SYSTEM, AND PROGRAM FOR EXECUTING THE INFORMATION PROCESSING METHOD ON COMPUTER

(71) Applicant: COLOPL, Inc., Tokyo (JP)

(72) Inventors: Kento NAKASHIMA, Tokyo (JP); Atsushi INOMATA, Kanagawa (JP); Kazuaki SAWAKI, Tokyo (JP)

(21) Appl. No.: 15/855,980

(22) Filed: Dec. 27, 2017

(30) Foreign Application Priority Data
Dec. 28, 2016 (JP) 2016-255367
Dec. 28, 2016 (JP) 2016-255372
Jul. 27, 2017 (JP) 2017-145948

(51) Int. Cl. G06F 3/01; G06T 15/20

(52) U.S. Cl. CPC G06F 3/012; G02B 27/0101; G06T 15/205; G06F 3/017

(57) ABSTRACT

[Object] To provide a field-of-view image in a virtual space that does not cause a first user to suffer VR sickness and that does not seem strange to a second user.

[Solving means] Provided is a method including: defining a virtual space, the virtual space including a first object associated with a first user, a second object associated with a second user, and a virtual viewpoint associated with the second object; identifying a position of the virtual viewpoint and, in accordance with motion of a head-mounted device (HMD) associated with the second user, a field of view in the virtual space; displaying on the HMD a field-of-view image corresponding to the field of view; identifying a first position at which the first object is to be arranged in the virtual space; acquiring information designating a second position, the second position being a position of a movement destination of the first object in the virtual space; identifying a guidance line from the first position toward the second position; moving the first object along the guidance line from the first position to the second position; displaying on the HMD the visual-field image including an animation representing that the first object is moving; identifying a third position at which the second object is arranged in the virtual space; acquiring information designating a fourth position, the fourth position being a position of a movement destination of the second object in the virtual space; moving the position of the virtual viewpoint from the third position to an observation position associated with the fourth position; and generating the field-of-view image during a transition period in which the position of the virtual viewpoint is moving, at least a part of the field-of-view images to be generated during a process of moving from the third position to the observation position being omitted.

### TECHNICAL FIELD

This disclosure relates to a technology for enabling chatting that uses a character object, for example, an avatar object, in a virtual space.

### BACKGROUND ART

In recent years, there have been proposed services in which chatting can be enjoyed in a virtual space, as disclosed in Non-Patent Document 1, for example.

### RELATED ART

### Non-Patent Documents

[Non-Patent Document 1] “Facebook Mark Zuckerberg Social VR Demo OC3 Oculus Connect 3 Keynote”, [online], Oct. 6, 2016, VRvibe, [retrieved on Dec. 5, 2016], Internet <https://www.youtube.com/watch?v=NCpNKLXovtE>

### SUMMARY

### Means for Solving the Problem

According to one embodiment of this disclosure, there is provided a method including: defining a virtual space, the virtual space including a first object associated with a first user, a second object associated with a second user, and a virtual viewpoint associated with the second object; identifying a position of the virtual viewpoint and, in accordance with motion of a head-mounted device (HMD) associated with the second user, a field of view in the virtual space; displaying on the HMD a field-of-view image corresponding to the field of view; identifying a first position at which the first object is arranged in the virtual space; acquiring information designating a second position, the second position being a position of a movement destination of the first object in the virtual space; identifying a guidance line from the first position toward the second position; moving the first object along the guidance line from the first position to the second position; displaying on the HMD the visual-field image including an animation representing that the first object is moving; identifying a third position at which the second object is to be arranged in the virtual space; acquiring information designating a fourth position, the fourth position being a position of a movement destination of the second object in the virtual space; moving the position of the virtual viewpoint from the third position to an observation position associated with the fourth position; and generating the field-of-view image during a transition period in which the position of the virtual viewpoint is moving, at least a part of the field-of-view images to be generated during a process of moving from the third position to the observation position being omitted.

### EFFECTS

### Brief Description of the Drawings

FIG. 1 A diagram for illustrating an overview of a configuration of an HMD system in one embodiment of this disclosure.

FIG. 2 A block diagram for illustrating an example of a hardware configuration of a computer in one embodiment of this disclosure.

FIG. 3 A diagram for schematically illustrating a uvw visual-field coordinate system to be set for an HMD in one embodiment of this disclosure.

FIG. 4 A diagram for schematically illustrating one mode of expressing a virtual space in one embodiment of this disclosure.

FIG. 5 A diagram for illustrating, from above, a head of a user wearing the HMD in one embodiment of this disclosure.

FIG. 6 A diagram for illustrating a YZ cross section obtained by viewing a field-of-view region from an X direction in the virtual space.

FIG. 7 A diagram for illustrating an XZ cross section obtained by viewing the field-of-view region from a Y direction in the virtual space.

FIGS. 8A Diagrams for illustrating a schematic configuration of a controller in one embodiment of this disclosure.

FIG. 8B A diagram for illustrating an example of a yaw direction, a roll direction, and a pitch direction that are defined with respect to a right hand of the user in one embodiment of this disclosure.

FIG. 9 A block diagram for illustrating an example of a hardware configuration of a server in one embodiment of this disclosure.

FIG. 10 A block diagram for illustrating a computer in one embodiment of this disclosure in terms of its module configuration.

FIG. 11 A sequence chart for illustrating a part of processing to be executed by an HMD set in one embodiment of this disclosure.

FIGS. 12A Schematic diagrams for illustrating a situation in which each HMD provides the user with the virtual space in a network.

FIG. 12B A diagram for illustrating a field-of-view image of a user 5A in FIG. 12A.

FIG. 13 A sequence diagram for illustrating processing to be executed by the HMD system in one embodiment of this disclosure.

FIG. 14 A block diagram of a configuration of modules of the computer according to at least one embodiment of this disclosure.

FIG. 15 A flowchart for illustrating processing to be executed by the HMD set.

FIG. 16 A diagram for schematically illustrating a virtual space shared by a plurality of users.

FIG. 17 A diagram for illustrating a field-of-view image to be provided to the user.

FIG. 18A A diagram for schematically illustrating a positional relationship among avatar objects before movement.

FIG. 18B A diagram for illustrating a field-of-view image of the avatar objects of FIG. 18A.

FIG. 19A A diagram for schematically illustrating a positional relationship among avatar objects at the time when a movement destination is designated.

FIG. 19B A diagram for illustrating a field-of-view image of the avatar objects of FIG. 19B.

FIG. 20A A diagram for schematically illustrating a positional relationship among avatar objects at the time when the movement destination has been arrived at.

FIG. 20B A diagram for schematically illustrating a field-of-view image of the avatar objects of FIG. 20B.

FIG. 21 A diagram for schematically illustrating a movement path for moving from a movement start point to the movement destination.

FIG. 22A A diagram for illustrating a specific example of the field-of-view image to be generated by the HMD worn by the user.

FIG. 22B A diagram for illustrating a specific example of the field-of-view image to be generated by the HMD worn by the user.

FIG. 22C A diagram for illustrating a specific example of the field-of-view image to be generated by the HMD worn by the user.

FIG. 23A A diagram for illustrating a field-of-view image to be provided to the user when the movement of the avatar object from the movement start point to the movement destination is viewed from the movement destination.

FIG. 23B A diagram for illustrating a field-of-view image to be provided to the user when the movement of the avatar object from the movement start point to the movement destination is viewed from the movement destination.

FIG. 23C A diagram for illustrating a field-of-view image to be provided to the user when the movement of the avatar object from the movement start point to the movement destination is viewed from the movement destination.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

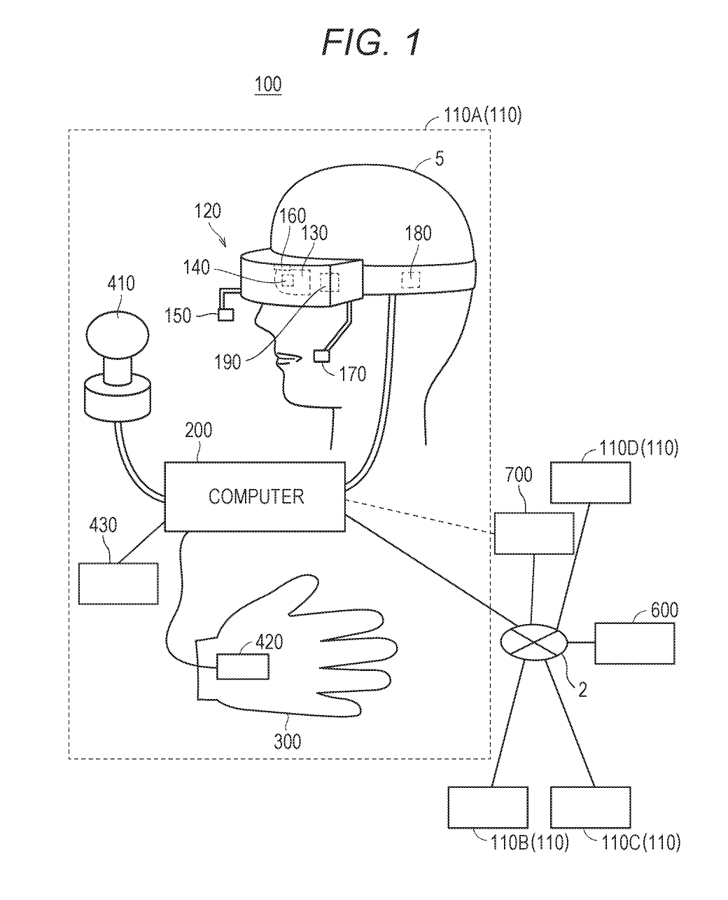

With reference to FIG. 1, a configuration of a head-mounted device (HMD) system 100 is described. FIG. 1 is a diagram for illustrating an overview of the configuration of the HMD system 100 in one embodiment of this disclosure. The HMD system 100 is provided as a system for household use or a system for professional use.

The HMD system. 100 includes a server 600, HMD sets 110A, 110B, 110C, and 110D, an external device 700, and a network 2. Each of the HMD sets 110A, 110B, 110C, and 110D is capable of communicating to/from the server 600 or the external device 700 via the network 2. In the following, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. The controller 300 may include a motion sensor 420.

In one aspect, the computer 200 can be connected to the network 2, for example, the Internet, and can communicate to/from the server 600 or other computers connected to the network 2. Examples of the other computers include a computer of another HMD set 110 and the external device 700. In another aspect, the HMD 120 may include a sensor 190 instead of the HMD sensor 410.

The HMD 120 may be worn on a head of a user 5 to provide a virtual space to the user 5 during operation. More specifically, the HMD 120 displays each of a right-eye image and a left-eye image on the monitor 130. When each eye of the user 5 visually recognizes each image, the user 5 may recognize the image as a three-dimensional image based on the parallax of both the eyes. The HMD 120 may include any one of a so-called head-mounted display including a monitor and a head-mounted device capable of mounting a smartphone or other terminals including a monitor.

The monitor 130 is implemented as, for example, a non-transmissive display device. In one aspect, the monitor 130 is arranged on a main body of the HMD 120 so as to be positioned in front of both the eyes of the user 5. Therefore, when the user 5 visually recognizes the three-dimensional image displayed on the monitor 130, the user 5 can be immersed in the virtual space. In one aspect, the virtual space includes, for example, a background, objects that can be operated by the user 5, and menu images that can be selected by the user 5. In one aspect, the monitor 130 may be implemented as a liquid crystal monitor or an organic electroluminescence (EL) monitor included in a so-called smartphone or other information display terminals.

In another aspect, the monitor 130 may be implemented as a transmissive display device. In this case, the HMD 120 is not a non-see-through HMD covering the eyes of the user 5 illustrated in FIG. 1, but maybe a see-through HMD, for example, smartglasses. The transmissive monitor 130 may be configured as a temporarily non-transmissive display device through adjustment of a transmittance thereof. The monitor 130 may be configured to display a real space and a part of an image constructing the virtual space at the same time. For example, the monitor 130 may display an image of the real space captured by a camera mounted on the HMD 120, or may enable recognition of the real space by setting the transmittance of a part the monitor 130 high.

In one aspect, the monitor 130 may include a sub-monitor for displaying a right-eye image and a sub-monitor for displaying a left-eye image. In another aspect, the monitor 130 may be configured to integrally display the right-eye image and the left-eye image. In this case, the monitor 130 includes a high-speed shutter. The high-speed shutter operates so as to enable alternate display of the right-eye image and the left-eye image so that only one of the eyes can recognize the image.

In one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In another aspect, the HMD sensor 410 may be implemented by a camera. In this case, the HMD sensor 410 may use image information of the HMD 120 output from the camera to execute image analysis processing, to thereby enable detection of the position and the inclination of the HMD 120.

In another aspect, the HMD 120 may include the sensor 190 instead of, or in addition to, the HMD sensor 410 as a position detector. The HMD 120 may use the sensor 190 to detect the position and the inclination of the HMD 120 itself. For example, when the sensor 190 is an angular velocity sensor, a geomagnetic sensor, or an acceleration sensor, the HMD 120 may use any of those sensors instead of the HMD sensor 410 to detect the position and the inclination of the HMD 120 itself. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In one aspect, the eye gaze sensor 140 is preferred to include a right-eye sensor and a left-eye sensor. The eye gaze sensor 140 may be, for example, a sensor configured to irradiate the right eye and the left eye of the user 5 with an infrared ray, and to receive reflection light from the cornea and the iris with respect to the irradiation light, to thereby detect a rotational angle of each eyeball. The eye gaze sensor 140 can detect the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In one aspect, the first camera 150 may be arranged outside of the HMD 120, and the second camera 160 may be arranged inside of the HMD 120. Images generated by the first camera 150 and the second camera 160 are input to the computer 200. In another aspect, the first camera 150 and the second camera 160 may be implemented as one camera, and the face of the user 5 may be photographed with this one camera.

The microphone 170 converts an utterance of the user 5 into a voice signal (electric signal) for output to the computer 200. The speaker 180 converts the voice signal into a voice for output to the user 5. In another aspect, the HMD 120 may include earphones in place of the speaker 180.

The controller 300 is connected to the computer 200 through wired or wireless communication. The controller 300 receives input of a command from the user 5 to the computer 200. In one aspect, the controller 300 can be held by the user 5. In another aspect, the controller 300 can be mounted to the body or a part of the clothes of the user 5. In still another aspect, the controller 300 may be configured to output at least any one of a vibration, a sound, or light based on the signal transmitted from the computer 200. In yet another aspect, the controller 300 receives from the user 5 an operation for controlling the position and the motion of an object arranged in the virtual space.

In one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In another aspect, the HMD sensor 410 may be implemented by a camera. In this case, the HMD sensor 410 may use image information of the controller 300 output from the camera to execute image analysis processing, to thereby enable detection of the position and the inclination of the controller 300.

In one aspect, the motion sensor 420 is mounted on the hand of the user 5 to detect the motion of the hand of the user 5. For example, the motion sensor 420 detects a rotational speed and the number of rotations of the hand. The detected signal is transmitted to the computer 200. The motion sensor 420 is provided to, for example, the controller 300. In one aspect, the motion sensor 420 is provided to, for example, the controller 300 capable of being held by the user 5. In another aspect, for the safety in the real space, the controller 300 is mounted on an object like a glove-type object that does not easily fly away by being worn on a hand of the user 5. In still another aspect, a sensor that is not mounted on the user 5 may detect the motion of the hand of the user 5. For example, a signal of a camera that photographs the user 5 may be input to the computer 200 as a signal representing the motion of the user 5. As one example, the motion sensor 420 and the computer 200 are connected to each other through wireless communication. In the case of wireless communication, the communication mode is not particularly limited, and for example, Bluetooth (trademark) or other known communication methods are used.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

The server 600 may transmit a program to the computer 200. In another aspect, the server 600 may communicate to/from another computer 200 for providing virtual reality to the HMD 120 used by another user. For example, when a plurality of users play a participatory game in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 may be any device as long as the external device 700 can communicate to/from the computer 200. The external device 700 may be, for example, a device capable of communicating to/from the computer 200 via the network 2, or may be a device capable of directly communicating to/from the computer 200 by near field communication or wired communication. Peripheral devices such as a smart device, a personal computer (PC), and the computer 200 may be used as the external device 700, but the external device 700 is not limited thereto.

Hardware Configuration of Computer

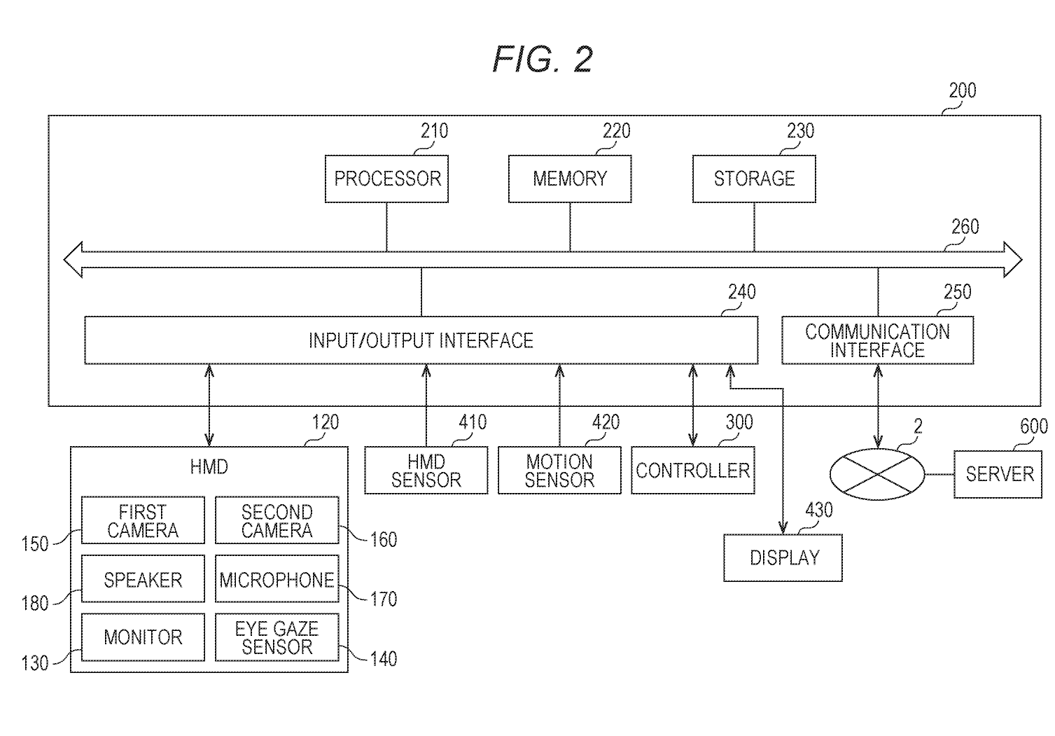

With reference to FIG. 2, the computer 200 in this embodiment is described. FIG. 2 is a block diagram for illustrating an example of the hardware configuration of the computer 200 in this embodiment. The computer 200 includes, as primary components, a processor 210, a memory 220, a storage 230, an input/output interface 240, and a communication interface 250. Each component is connected to a bus 260.

The processor 210 executes a series of commands included in a program stored in the memory 220 or the storage 230 based on a signal transmitted to the computer 200 or on satisfaction of a condition determined in advance. In one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In one aspect, the memory 220 is implemented as a random access memory (RAM) or other volatile memories.

The storage 230 permanently stores programs and data. The storage 230 is implemented as, for example, a read-only memory (ROM), a hard disk device, a flash memory, or other non-volatile storage devices. The programs stored in the storage 230 include programs for providing a virtual space in the HMD system 100, simulation programs, game programs, user authentication programs, and programs for implementing communication to/from other computers 200. The data stored in the storage 230 includes data and objects for defining the virtual space.

In another aspect, the storage 230 may be implemented as a removable storage device like a memory card. In still another aspect, a configuration that uses programs and data stored in an external storage device may be used instead of the storage 230 built into the computer 200. With such a configuration, for example, in a situation in which a plurality of HMD systems 100 are used as in an amusement facility, the programs and the data can be collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In one aspect, the input/output interface 240 is implemented with use of a universal serial bus (USB), a digital visual interface (DVI), a high-definition multimedia interface (HDMI) (trademark), or other terminals. The input/output interface 240 is not limited to ones described above.

In one aspect, the input/output interface 240 may further communicate to/from the controller 300. For example, the input/output interface 240 receives input of a signal output from the controller 300 and the motion sensor 420. In another aspect, the input/output interface 240 transmits a command output from the processor 210 to the controller 300. The command instructs the controller 300 to, for example, vibrate, output a sound, or emit light. When the controller 300 receives the command, the controller 300 executes anyone of vibration, sound output, and light emission in accordance with the command.

The communication interface 250 is connected to the network 2 to communicate to/from other computers (e.g., server 600) connected to the network 2. In one aspect, the communication interface 250 is implemented as, for example, a local area network (LAN), other wired communication interfaces, wireless fidelity (Wi-Fi), Bluetooth (trademark), near field communication (NFC), or other wireless communication interfaces. The communication interface 250 is not limited to ones described above.

In one aspect, the processor 210 accesses the storage 230 and loads one or more programs stored in the storage 230 to the memory 220 to execute a series of commands included in the program. The one or more programs may include an operating system of the computer 200, an application program for providing a virtual space, and game software that can be executed in the virtual space. The processor 210 transmits a signal for providing a virtual space to the HMD 120 via the input/output interface 240. The HMD 120 displays a video on the monitor 130 based on the signal.

In the example illustrated in FIG. 2, the computer 200 is provided outside of the HMD 120, but in another aspect, the computer 200 may be built into the HMD 120. As an example, a portable information communication terminal (e.g., smartphone) including the monitor 130 may function as the computer 200.

The computer 200 may be used in common among a plurality of HMDs 120. With such a configuration, for example, the same virtual space can be provided to a plurality of users, and hence each user can enjoy the same application with other users in the same virtual space.

According to one embodiment of this disclosure, in the HMD system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which correspond to the motion of the user 5 wearing the HMD 120, based on the value of each point (each coordinate value in the real coordinate system). In more detail, the HMD sensor 410 can detect the temporal change of the position and the inclination of the HMD 120 with use of each value detected over time.

Each inclination of the HMD 120 detected by the HMD sensor 410 corresponds to each inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

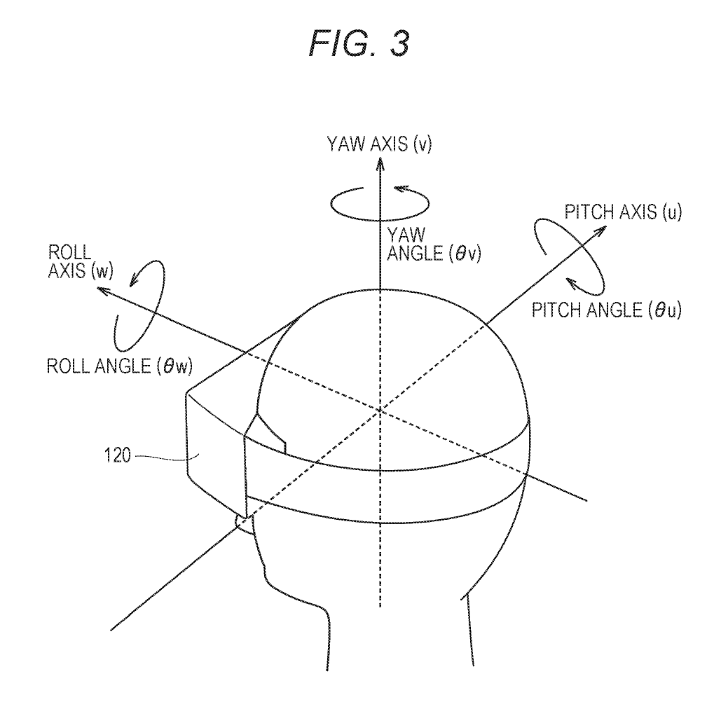

With reference to FIG. 3, the uvw visual-field coordinate system is described. FIG. 3 is a diagram for schematically illustrating a uvw visual-field coordinate system to be set for the HMD 120 in one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

As illustrated in FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In one aspect, when the user 5 wearing the HMD 120 is standing upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 can detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is always constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In one aspect, the HMD sensor 410 may identify the position of the HMD 120 in the real space as a position relative to the HMD sensor 410 based on the light intensity of the infrared ray or a relative positional relationship between a plurality of points (e.g., distance between points), which is acquired based on output from the infrared sensor. The processor 210 may determine the origin of the uvw visual-field coordinate system of the HMD 120 in the real space (real coordinate system) based on the identified relative position.

[Virtual Space]

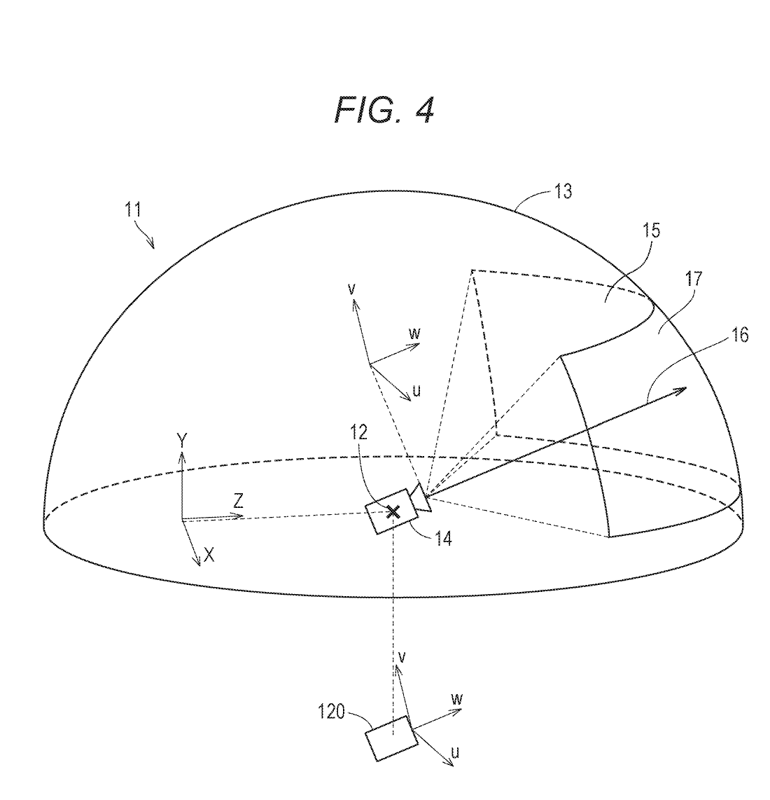

With reference to FIG. 4, the virtual space is further described. FIG. 4 is a diagram for schematically illustrating one mode of expressing a virtual space 11 in one embodiment of this disclosure. The virtual space 11 has a structure with an entire celestial sphere shape covering a center 12 in all 360-degree directions. In FIG. 4, in order to avoid complicated description, only the upper-half celestial sphere of the virtual space 11 is exemplified. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that can be developed in the virtual space 11 with each corresponding mesh section in the virtual space 11.

In one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space maybe reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 can be said to be a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the HMD system 100 in one aspect, the line of sight of the user 5 detected by the eye gaze sensor 140 can be regarded as the line of sight of the user 5 in the uvw visual-field coordinate system of the virtual camera 14.

[User's Line of Sight]

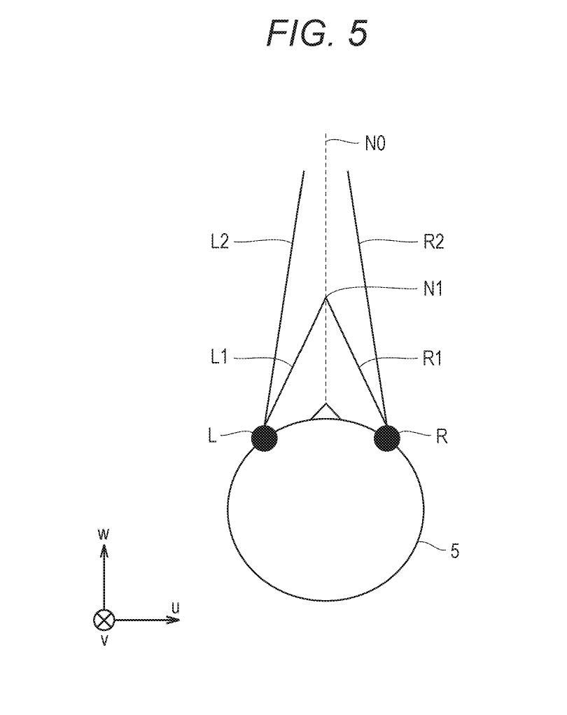

With reference to FIG. 5, determination of the line of sight of the user 5 is described. FIG. 5 is a diagram for illustrating, from above, the head of the user 5 wearing the HMD 120 in one embodiment of this disclosure.

In one aspect, the eye gaze sensor 140 detects lines of sight of the right eye and the left eye of the user 5. In one aspect, when the user 5 is looking at a near place, the eye gaze sensor 140 detects lines of sight R1 and L1. In another aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In another aspect, the HMD system 100 may include a television broadcast reception tuner. With such a configuration, the HMD system 100 can display a television program in the virtual space 11.

In still another aspect, the HMD system 100 may include a communication circuit for connecting to the Internet or have a verbal communication function for connecting to a telephone line.

[Field-of-View Region]

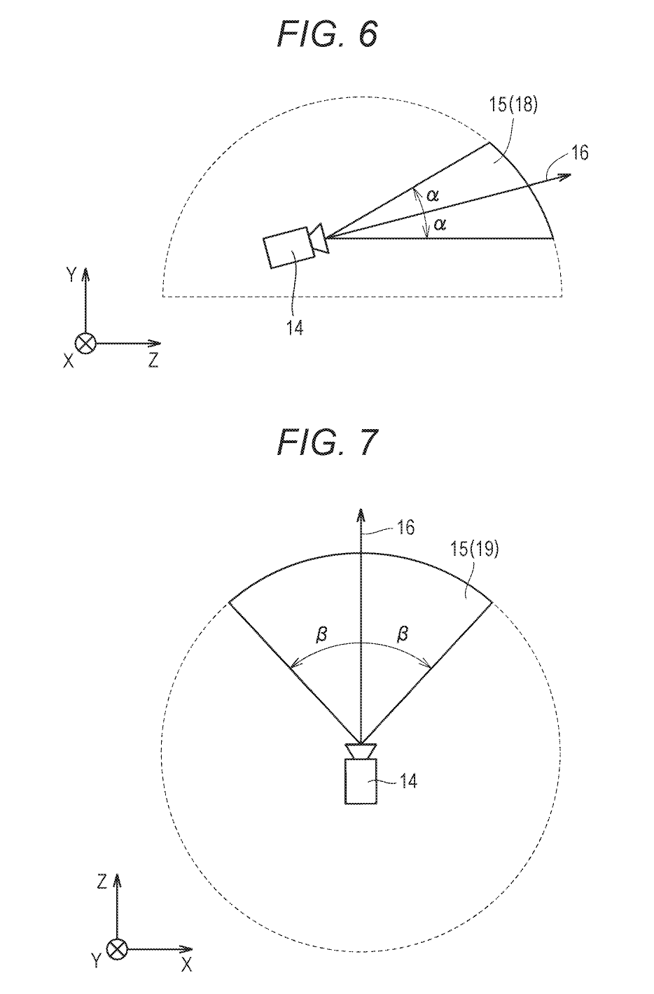

With reference to FIG. 6 and FIG. 7, the field-of-view region 15 is described. FIG. 6 is a diagram for illustrating a YZ cross section obtained by viewing the field-of-view region 15 from an X direction in the virtual space 11. FIG. 7 is a diagram for illustrating an XZ cross section obtained by viewing the field-of-view region 15 from a Y direction in the virtual space 11.

As illustrated in FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

As illustrated in FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth p from the reference line of sight 16 serving as the center in the virtual space 11 as the region 19. The polar angle a and p are determined in accordance with the position of the virtual camera 14 and the inclination (direction) of the virtual camera 14.

In one aspect, the HMD system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120, the user 5 can visually recognize only the panorama image 13 developed in the virtual space 11 without visually recognizing the real world. Therefore, the HMD system 100 can provide a high sense of immersion in the virtual space 11 to the user 5.

In one aspect, the processor 210 may move the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In one aspect, the virtual camera 14 may include two virtual cameras, that is, a virtual camera for providing a right-eye image and a virtual camera for providing a left-eye image. An appropriate parallax is set for the two virtual cameras so that the user 5 can recognize the three-dimensional virtual space 11. In another aspect, the virtual camera 14 may be implemented by one virtual camera. In this case, a right-eye image and a left-eye image may be generated from an image acquired by one virtual camera. In this embodiment, the technical idea of this disclosure is exemplified assuming that the virtual camera 14 includes two virtual cameras, and the roll axes of the two virtual cameras are synthesized so that the generated roll axis (w) is adapted to the roll axis (w) of the HMD 120.

[Controller]

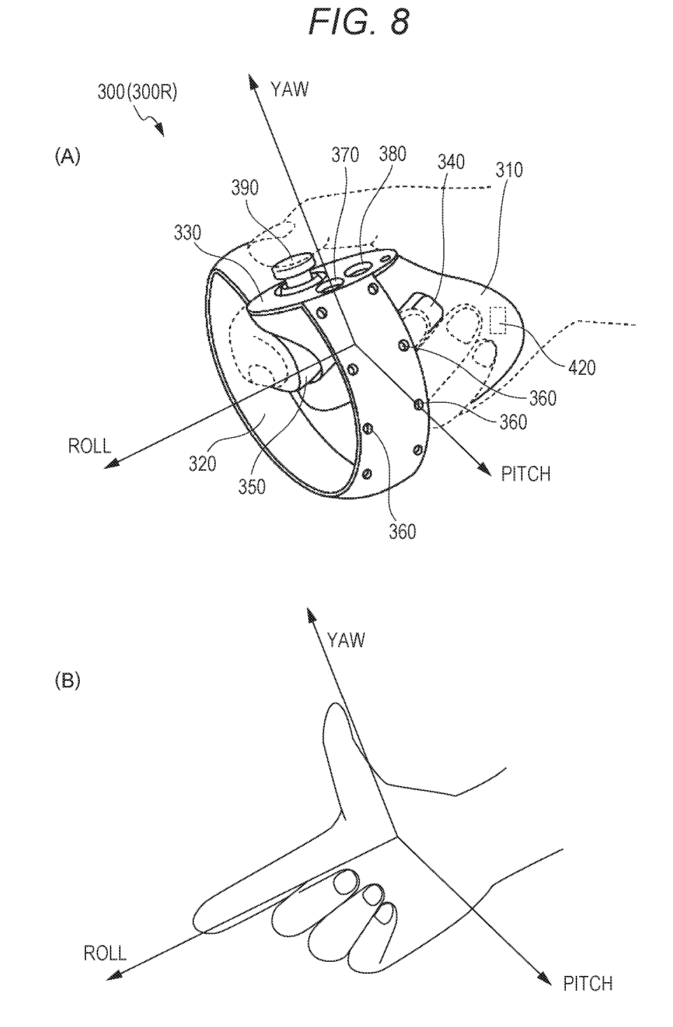

An example of the controller 300 is described with reference to FIGS. 8. FIGS. 8 are diagrams for illustrating a schematic configuration of the controller 300 in one embodiment of this disclosure.

As illustrated in FIGS. 8, in one aspect, the controller 300 may include a right controller 300R and a left controller (not shown). The right controller 300R is operated by the right hand of the user 5. The left controller is operated by the left hand of the user 5. In one aspect, the right controller 300R and the left controller are symmetrically configured as separate devices. Therefore, the user 5 can freely move his or her right hand holding the right controller 300R and his or her left hand holding the left controller. In another aspect, the controller 300 may be an integrated controller configured to receive an operation performed by both hands. The right controller 300R is now described.

The right controller 300R includes a grip 310, a frame 320, and a top surface 330. The grip 310 is configured so as to be held by the right hand of the user 5. For example, the grip 310 may be held by the palm and three fingers (middle finger, ring finger, and small finger) of the right hand of the user 5.

The grip 310 includes buttons 340 and 350 and the motion sensor 420. The button 340 is arranged on a side surface of the grip 310, and receives an operation performed by the middle finger of the right hand. The button 350 is arranged on a front surface of the grip 310, and receives an operation performed by the index finger of the right hand. In one aspect, the buttons 340 and 350 are configured as trigger type buttons. The motion sensor 420 is built into the casing of the grip 310. When a motion of the user 5 can be detected from the surroundings of the user 5 by a camera or other device, it is not required for the grip 310 to include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 may be used to detect the position and the posture (inclination and direction) of each of the right controller 300R and the left controller. In the example illustrated in FIGS. 8, the infrared LEDs 360 are shown as being arranged in two rows, but the number of arrangement rows is not limited to that illustrated in FIGS. 8. The infrared LEDs 360 may be arranged in one row or in three or more rows.

The top surface 330 includes buttons 370 and 380 and an analog stick 390. The buttons 370 and 380 are configured as push type buttons. The buttons 370 and 380 receive an operation performed by the thumb of the right hand of the user 5. In one aspect, the analog stick 390 receives an operation performed in any direction of 360 degrees from an initial position (neutral position). The operation includes, for example, an operation for moving an object arranged in the virtual space 11.

In one aspect, each of the right controller 300R and the left controller includes a battery for driving the infrared ray LEDs 360 and other members. The battery includes, for example, a rechargeable battery, a button battery, a dry battery, but the battery is not limited thereto. In another aspect, the right controller 300R and the left controller may be connected to, for example, a USB interface of the computer 200. In this case, the right controller 300R and the left controller do not require a battery.

In FIG. 8A and FIG. 8B, for example, a yaw direction, a roll direction, and a pitch direction are defined with respect to the right hand of the user 5. A direction of extending the thumb, a direction of extending the index finger, and a direction perpendicular to a plane defined by the yaw-direction axis and the roll-direction axis when the user 5 extends his or her thumb and index finger are defined as the yaw direction, the roll direction, and the pitch direction, respectively.

[Hardware Configuration of Server]

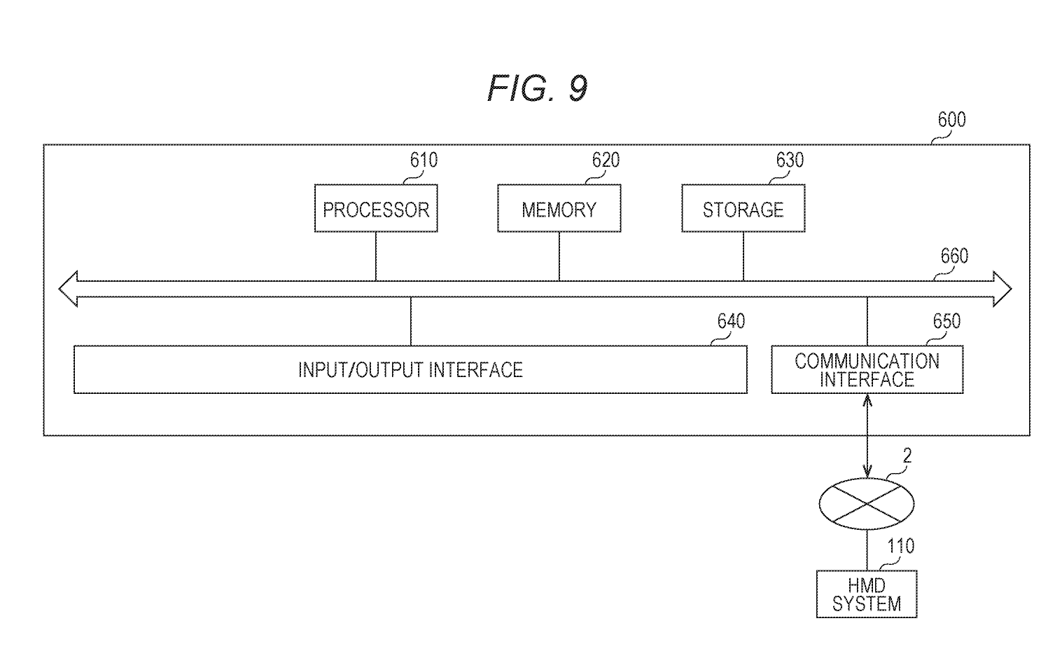

With reference to FIG. 9, the server 10 in this embodiment is described. FIG. 9 is a block diagram for illustrating an example of a hardware configuration of the server 600 in one embodiment of this disclosure. The server 600 includes, as primary components, a processor 610, a memory 620, a storage 630, an input/output interface 640, and a communication interface 650. Each component is connected to a bus 660.

The processor 610 executes a series of commands included in a program stored in the memory 620 or the storage 630 based on a signal transmitted to the server 600 or on satisfaction of a condition determined in advance. In one aspect, the processor 10 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In one aspect, the memory 620 is implemented as a random access memory (RAM) or other volatile memories.

The storage 630 permanently stores programs and data. The storage 630 is implemented as, for example, a read-only memory (ROM), a hard disk device, a flash memory, or other non-volatile storage devices. The programs stored in the storage 630 include programs for providing a virtual space in the HMD system 100, simulation programs, game programs, user authentication programs, and programs for implementing communication to/from other computers 200. The data stored in the storage 630 may include, for example, data and objects for defining the virtual space.

In another aspect, the storage 630 may be implemented as a removable storage device like a memory card. In another aspect, a configuration that uses programs and data stored in an external storage device may be used instead of the storage 630 built into the server 600. With such a configuration, for example, in a situation in which a plurality of HMD systems 100 are used as in an amusement facility, the programs and the data can be collectively updated.

The input/output interface 640 allows communication of signals to/from an input/output device. In one aspect, the input/output interface 640 is implemented with use of a USB, a DVI, an HDMI, or other terminals. The input/output interface 640 is not limited to ones described above.

The communication interface 650 is connected to the network 2 to communicate to/from the computer 200 connected to the network 2. In one aspect, the communication interface 650 is implemented as, for example, a LAN, other wired communication interfaces, Wi-Fi, Bluetooth, NFC, or other wireless communication interfaces. The communication interface 650 is not limited to ones described above.

In one aspect, the processor 610 accesses the storage 630 and loads one or more programs stored in the storage 630 to the memory 620 to execute a series of commands included in the program. The one or more programs may include, for example, an operating system of the server 610, an application program for providing a virtual space, and game software that can be executed in the virtual space. The processor 610 may transmit a signal for providing a virtual space to the HMD device 110 to the computer 200 via the input/output interface 640.

[Control Device of HMD]

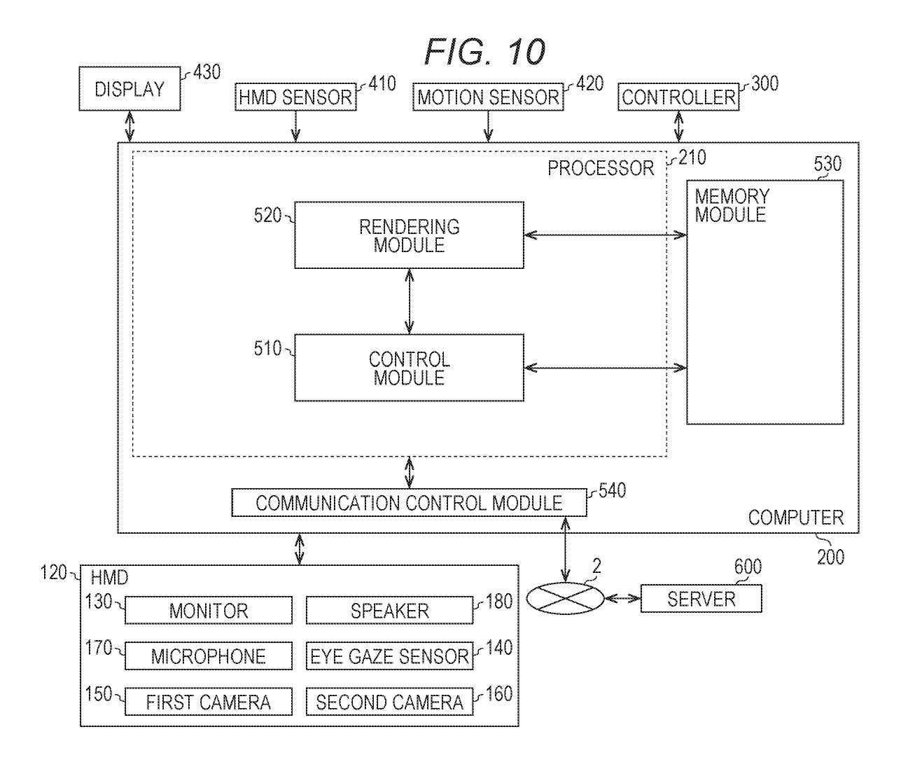

With reference to FIG. 10, the control device of the HMD 21 is described. According to one embodiment of this disclosure, the control device is implemented by the computer 200 having a known configuration. FIG. 10 is a block diagram for illustrating the computer 200 in one embodiment of this disclosure in terms of its module configuration.

As illustrated in FIG. 10, the computer 200 includes a control module 510, a rendering module 520, a memory module 530, and a communication control module 540. In one aspect, the control module 510 and the rendering module 520 are implemented by the processor 210. In another aspect, a plurality of processors 210 may actuate as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. The control module 510 may generate virtual space data by itself or acquire virtual space data from, for example, the server 600.

The control module 510 arranges objects in the virtual space 11 using object data representing objects. The object data is stored in, for example, the memory module 530. The control module 510 may generate virtual space data by itself or acquire object data from, for example, the server 600. The objects may include, for example, an avatar object of the user 5, character objects, operation objects, for example, a virtual hand to be operated by the controller 300, and forests, mountains, other landscapes, streetscapes, and animals to be arranged in accordance with the progression of the story of the game.

The control module 510 arranges an avatar object of the user 5 of another computer 200, which is connected via the network 2, in the virtual space 11. In one aspect, the control module 510 arranges an avatar object of the user 5 in the virtual space 11. In one aspect, the control module 510 arranges an avatar object simulating the user 5 in the virtual space 11 based on an image including the user 5. In another aspect, the control module 510 arranges an avatar object in the virtual space 2, which is selected by the user 5 from among a plurality of types of avatar objects (e.g., objects simulating animals or objects of deformed humans).

The control module 510 identifies an inclination of the HMD 120 based on output of the HMD sensor 410. In another aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In another aspect, the control module 510 may be configured to transmit line-of-sight information representing the line of sight of the user 5 to the server 600. In such a case, the control module 510 may calculate the point-of-view position based on the line-of-sight information received by the server 600.

The control module 510 reflects a motion of the HMD 120, which is detected by the HMD sensor 410, in an avatar object. For example, the control module 510 detects inclination of the HMD 120, and arranges the avatar object in an inclined manner. The control module 510 reflects the detected motion of face parts in a face of the avatar object arranged in the virtual space 11. The control module 510 receives line-of-sight information of another user 5 from the server 600, and reflects the line-of-sight information in the line of sight of the avatar object of another user 5. In one aspect, the control module 510 reflects a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In one aspect, the operation object may include, for example, a hand object serving as a virtual hand corresponding to a hand of the user 5. In one aspect, the control module 510 moves the hand object in the virtual space 11 so that the hand object moves in association with a motion of the hand of the user 5 in the real space based on output of the motion sensor 420. In one aspect, the operation object may correspond to a hand part of an avatar object.

When one object arranged in the virtual space 11 collides with another object, the control module 510 detects the collision. The control module 510 can detect, for example, a timing at which a collision area of one object and a collision area of another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. For example, when an operation object touches with another object, the control module 510 detects the fact that the operation object has touched with another object, and performs predetermined processing.

In one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 510 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs voices (utterances) corresponding to the voice data from the speaker 180.

The memory module 530 holds data to be used to provide the virtual space 11 to the user 5 by the computer 200. In one aspect, the memory module 530 holds space information, object information, and user information.

The space information holds one or more templates defined to provide the virtual space 11.

The object information stores a plurality of panorama images 13 forming the virtual space 11 and object data for arranging objects in the virtual space 11. The panorama image 13 may contain a still image and a moving image. The panorama image 13 may contain an image in a non-real space and an image in the real space. An example of the image in a non-real space is an image generated by computer graphics.

The user information stores a user ID for identifying the user 5. The user ID may be, for example, an internet protocol (IP) address or a media access control (MAC) address set to the computer 200 used by the user. In another aspect, the user ID maybe set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

The communication control module 540 may communicate to/from the server 600 or other information communication devices via the network 2.

In one aspect, the control module 510 and the rendering module 520 may be implemented with use of, for example, Unity (trademark) provided by Unity Technologies. In another aspect, the control module 510 and the rendering module 520 may also be implemented by combining the circuit elements for implementing each step of processing.

The processing performed in the computer 200 is implemented by hardware and software executed by the processor 410. The software may be stored in advance on a hard disk or other memory module 530. The software may also be stored on a CD-ROM or other computer-readable non-volatile data recording media, and distributed as a program product. The software may also be provided as a program product that can be downloaded by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

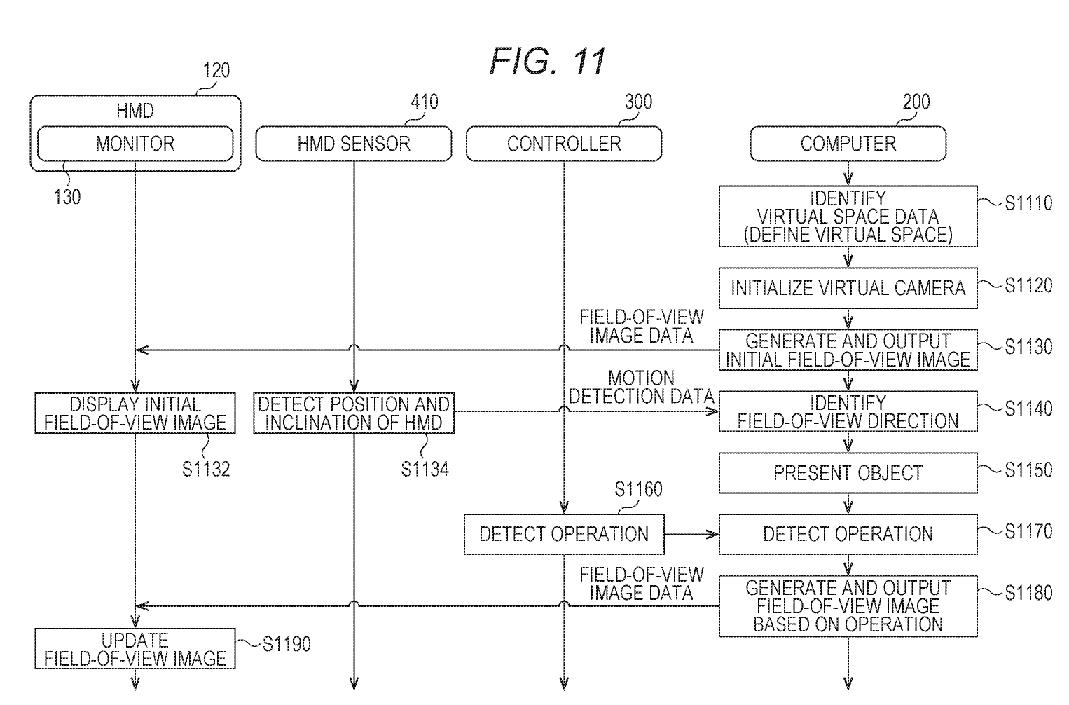

With reference to FIG. 11, the control structure of the HMD set 110 is described. FIG. 11 is a sequence chart for illustrating a part of processing to be executed by the HMD system 100 in one embodiment of this disclosure.

As illustrated in FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In another aspect, an operation of the controller 300 by the user 5 may be detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

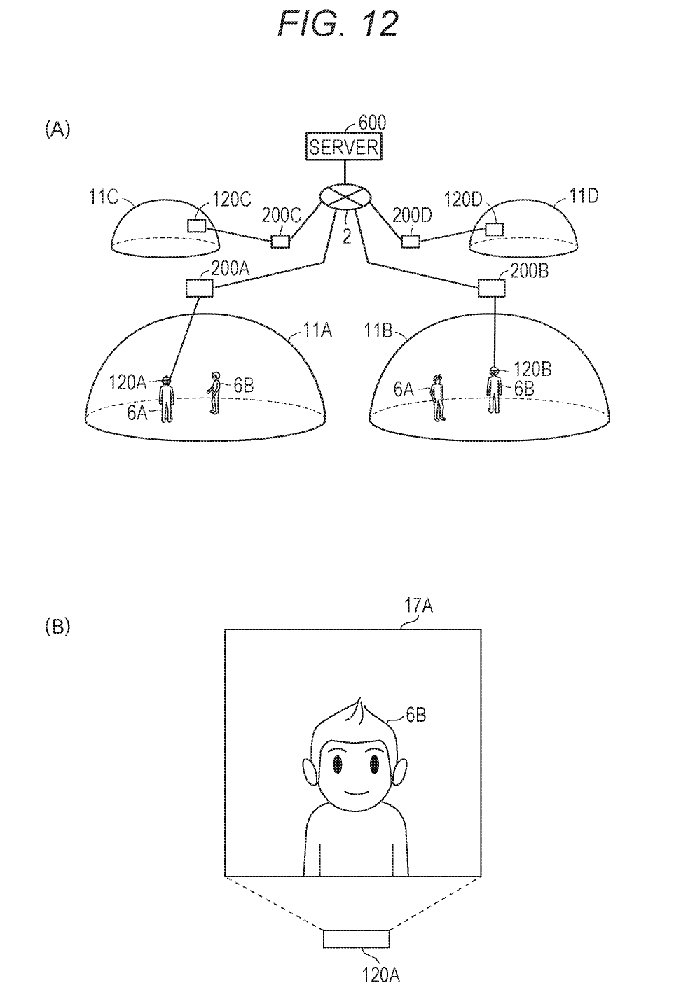

With reference to FIG. 12(A) and FIG. 12(B), an avatar object in this embodiment is described. FIG. 12(A) and FIG. 12(B) are diagrams for illustrating avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12(A) is a schematic diagram for illustrating a situation in which each HMD 120 provides the user 5 with the virtual space 11. Computers 200A to 200D provide the users 5A to 5D with virtual spaces 11A to 11D via HMDs 120A to 120D, respectively. In the example illustrated in FIG. 12(A), the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, this illustration is only for the sake of simplicity of description, and those objects do not wear the HMD 120 in actuality.

In one aspect, the processor 210A may arrange a virtual camera 14A for photographing a field-of-view region 17A of the user 5A at the position of eyes of the avatar object 6A.

FIG. 12(B) is a diagram for illustrating the field-of-view region 17A of the user 5A in FIG. 12(A). The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not particularly illustrated in FIG. 12B, the avatar object 6A of the user 5A is displayed in the field-of-view image of the user 5B.

Under the state of FIG. 12(B), the user 5A can communicate to/from the user 5B via the virtual space 11A through conversation. More specifically, voices of the user 5A acquired by a microphone 170A are transmitted to the HMD 17120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A reflects an operation by the user 5B (operation of HMD 120B and operation of controller 300B) in the avatar object 6B arranged in the virtual space 11A. With this, the user 5A can recognize the operation by the user 5B through the avatar object 6B.

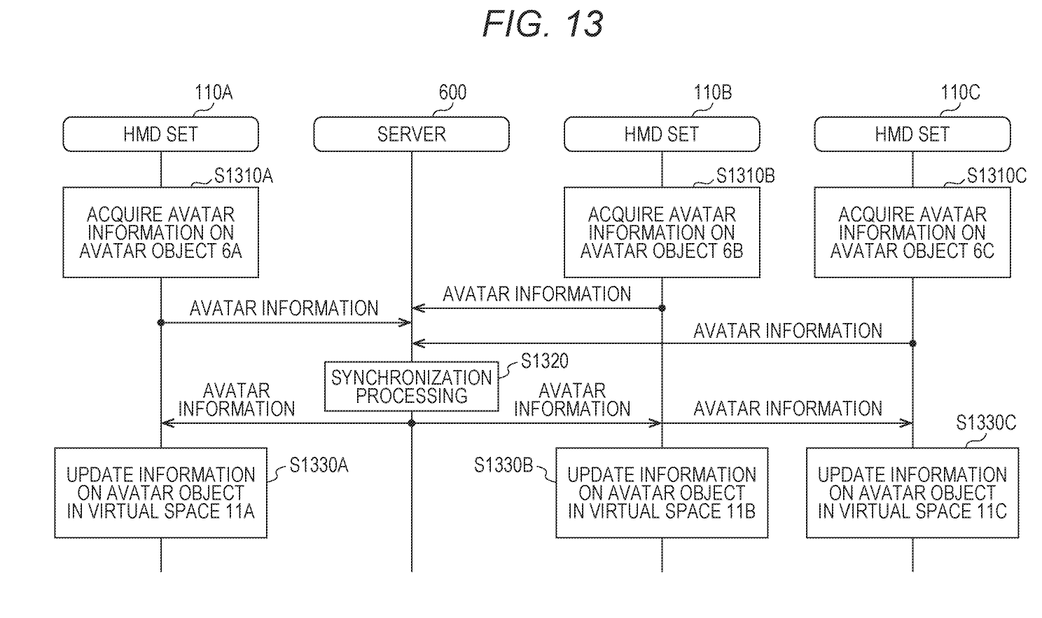

FIG. 13 is a sequence chart for illustrating a part of processing to be executed by the HMD system 100 in this embodiment. In FIG. 13, although the HMD set 110D is not illustrated, the HMD set 110D operates in the same manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. The avatar information may contain information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210B of the HMD set 110B acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 11020C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 540. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Details of Module Configuration]

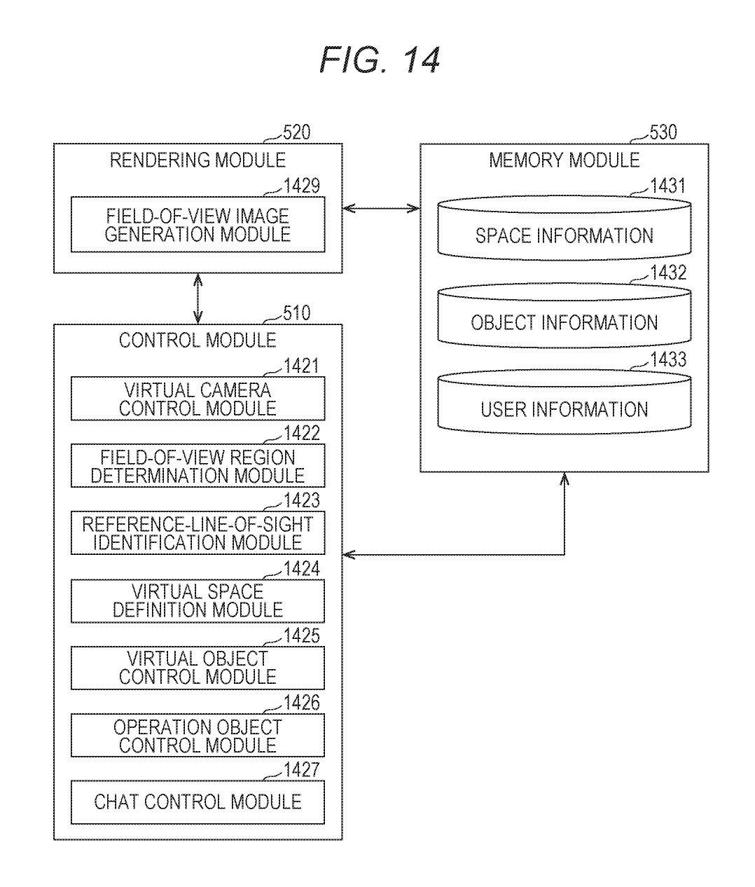

With reference to FIG. 14, details of a module configuration of the computer 200 are described. FIG. 14 is a block diagram of a configuration of modules of the computer according to at least one embodiment of this disclosure.

As illustrated in FIG. 14, the control module 510 includes a virtual camera control module 1421, a field-of-view region determination module 1422, a reference-line-of-sight identification module 1423, a virtual space definition module 1424, a virtual object control module 1425, an operation object control module 1426, and a chat control module 1427. The rendering module 520 includes a field-of-view image generation module 1429. The memory module 530 stores space information 1431, object information 1432, and user information 1433.

In one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user wearing the HMD 120. The field-of-view image generation module 1429 generates a field-of-view image to be displayed on the monitor 130 based on the determined field-of-view region 15. The field-of-view image generation module 1429 determines a display mode of an avatar object (to be described later in detail) to be included in the field-of-view image. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object generation module 1425 generates target objects to be arranged in the virtual space 11. The virtual object control module 1425 controls the motion (e.g., movements and state changes) of the target object and the avatar object in the virtual space 11. The target object may include, for example, a landscape including a forest, a mountain, and other scenery, and an animal to be arranged in accordance with the progress of the game story. The avatar object is an object associated with the user wearing the HMD 120 in the virtual space 11, and may be referred to as an avatar. In this disclosure, an object including an avatar is referred to as an avatar object.

The operation object control module 1426 arranges in the virtual space 11 an operation object for operating an object to be arranged in the virtual space 11. In one aspect, the operation object may include, for example, a hand object corresponding to a hand of the user wearing the HMD 120, a finger object corresponding to a finger of the user, and a stick object corresponding to a stick used by the user. When the operation object is a finger object, in particular, the operation object corresponds to a portion of the axis in a direction (axial direction) indicated by the finger.

The chat control module 1427 performs control for chatting with a player character of another user who is in the same virtual space 11. For example, the chat control module 1427 transmits to the server 600 information on the position, direction, and the like of the avatar object of the user, and sound data input to the microphone 170. The chat control module 1427 outputs the sound data of another user received from the server 600 to a speaker (not shown). As a result, a sound-based chat is implemented. The chat is not limited to communication based on sound data, and can also be based on text data. In this case, the chat control module 234 controls the transmission and reception of the text data.

The space information 1431 includes one or more templates that are defined to provide the virtual space 11. The object information 1432 includes, for example, content to be reproduced in the virtual space 11 and information for arranging an object to be used in the content. The content may include, for example, a game or content representing a scenery similar to that of the real society. The user information 1433 includes, for example, a program for causing the computer 200 to function as a control device for the HMD set 110, and an application program that uses each piece of content stored in the object information 1432.

[Control Structure]

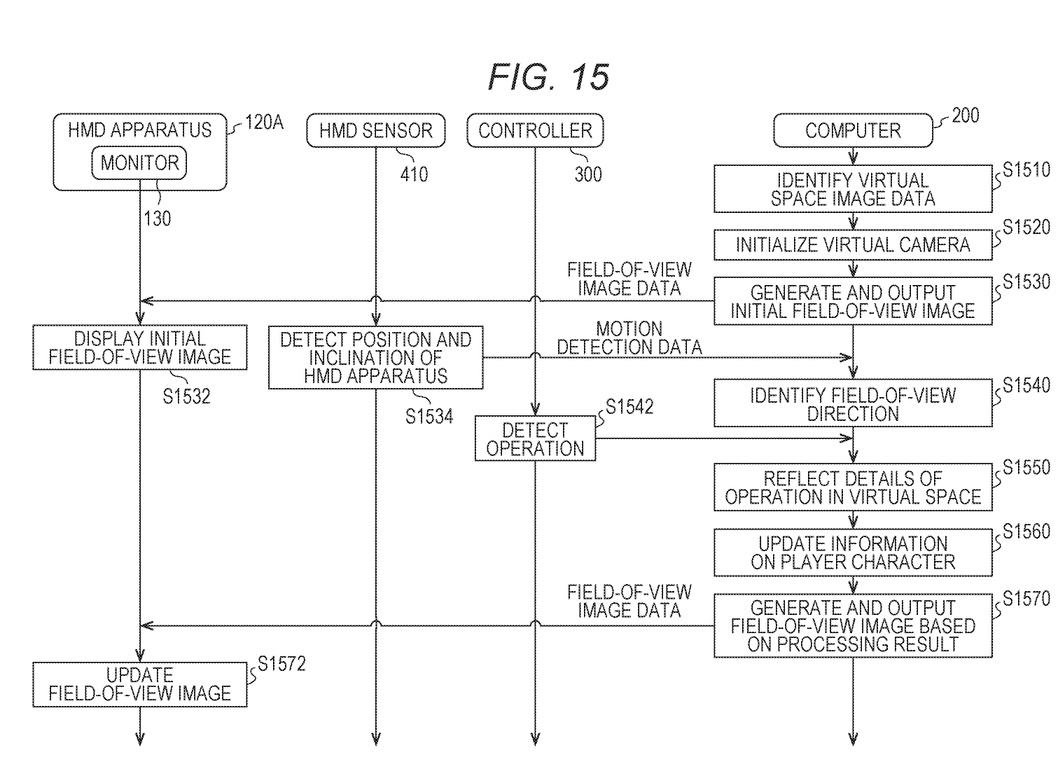

With reference to FIG. 15, the control structure of the computer 200 in one embodiment of this disclosure is described. FIG. 15 is a flowchart for illustrating processing to be executed by the HMD set 110A, which is used by the user 5A (first user), to provide the virtual space 11 to the user 5A.

In Step S1510, the processor 210 of the computer 200 serves as the virtual space definition module 1424 to identify virtual space image data and define the virtual space 11.

In Step S1520, the processor 210 serves as the virtual camera control module 1421 to initialize the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1530, the processor 210 serves as the field-of-view image generation module 1429 to generate field-of-view image data for displaying an initial field-of-view image. The generated field-of-view image data is transmitted to the HMD 120 by the communication control module 540 via the field-of-view image generation module 1429.

In Step S1532, the monitor 130 of the HMD 120 displays a field-of-view image based on a signal received from the computer 200. The user 5 wearing the HMD 120 may recognize the virtual space 11 through visual recognition of the field-of-view image.

In Step S1534, the HMD sensor 410 detects the position and the inclination of the HMD 120 based on a plurality of infrared rays emitted from the HMD 120. The detection results are transmitted to the computer 200 as motion detection data.

In Step S1540, the processor 210 serves as the field-of-view region determination module 1422 to identify a field-of-view direction of the user 5 wearing the HMD 120 based on the position and inclination of the HMD 120. The processor 210 executes an application program, and arranges an object in the virtual space 11 based on a command contained in the application program.

In Step S1542, the controller 300 detects an operation performed by the user 5 in the real space. For example, in one aspect, the controller 300 detects that a button has been pressed by the user 5. In another aspect, the controller 300 detects motion of both hands of the user 5 (e.g., waving both hands). A signal indicating details of the detection is transmitted to the computer 200.

In Step S1550, the processor 210 serves as the operation object control module 1426 to reflect in the virtual space 11 the details of the detection transmitted from the controller 300. More specifically, the processor 210 moves the operation object (e.g., hand object representing the hand of the avatar object) in the virtual space 11 based on a signal indicating the details of the detection. The processor 210 serves as the operation object control module 1426 to detect an operation (e.g., a grip operation) determined in advance on the target object by the operation object.

In Step S1560, the processor 210 updates, based on information (avatar information to be described later) transmitted from the HMD sets 110B and 110C used by the other users 5B and 5C (second users), the information on the avatar objects associated with the other users. Specifically, the processor 210 serves as the virtual object control module 1425 to update the information on the position, direction, and the like of the avatar object associated with each of the other users in the virtual space 11.

In Step S1570, the processor 210 serves as the field-of-view image generating module 1429 to generate field-of-view image data for displaying a field-of-view image based on the results of the processing in Step S1550 and Step S1560, and output the generated field-of-view image data to the HMD 120. When generating the field-of-view image data, the processor 210 determines the display mode of the avatar object to be included in the field-of-view image. Whether or not an avatar object is to be included in the field-of-view image depends on, for example, whether or not the player character is to be included in the field-of-view region 15 determined based on the field-of-view direction identified in Step S1540.

In Step S1572, the monitor 130 of the HMD 120 updates a field-of-view image based on the received field-of-view image data, and displays the updated field-of-view image.

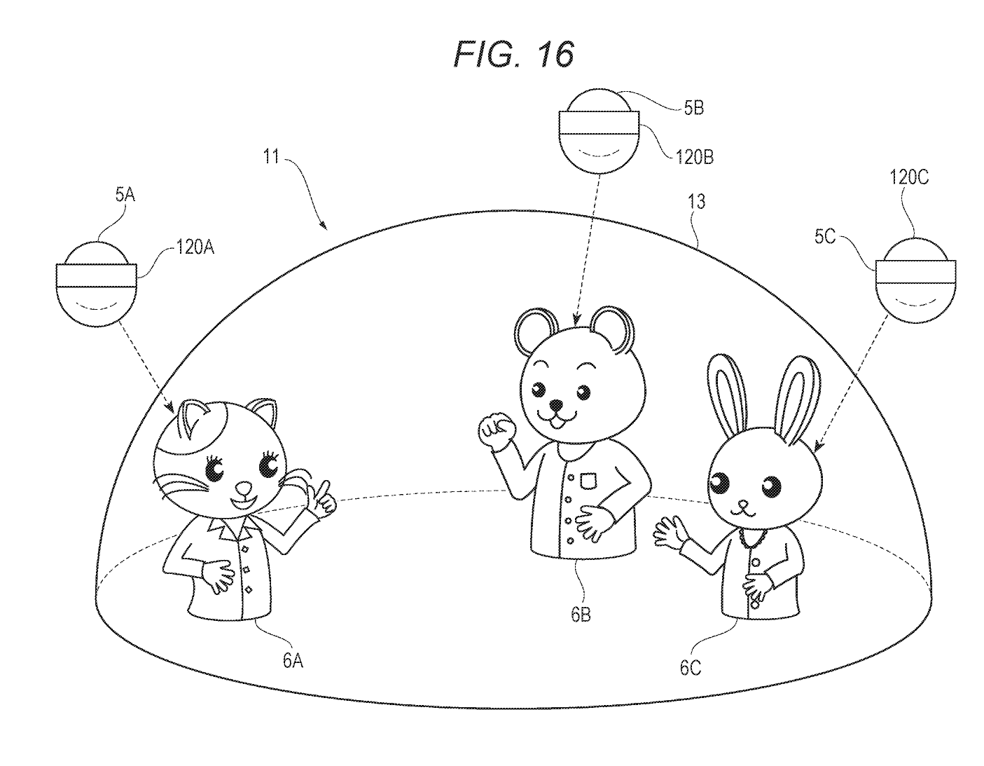

FIG. 16 is a diagram for schematically illustrating the virtual space 11 shared by a plurality of users. In the example illustrated in FIG. 16, the avatar object 6A (first avatar object) associated with the user 5A wearing the HMD 120A, the avatar object 6B (second avatar object) associated with the user 5B wearing the HMD 120B, and the avatar object 6C (second avatar object) associated with the user 5C wearing the HMD 120C are arranged in the same virtual space 11. In such a virtual space 11 shared by a plurality of users, a communication experience, for example, chat (VR chat) with other users via the avatar objects 6, can be provided to each user.

In this example, each avatar object 6 is defined as an object imitating an animal (cat, rabbit, or bear). The avatar objects 6 include a head moving in conjunction with the motion of the HMD 120 detected by the HMD sensor 410 or the like, hands moving in conjunction with the motion of the hands of the user detected by the motion sensor 420 or the like, and a body and arms displayed in association with the head and the hands. Motion control of legs lower than hips is complicated, and hence it is not always required for the avatar objects 6 to include legs.

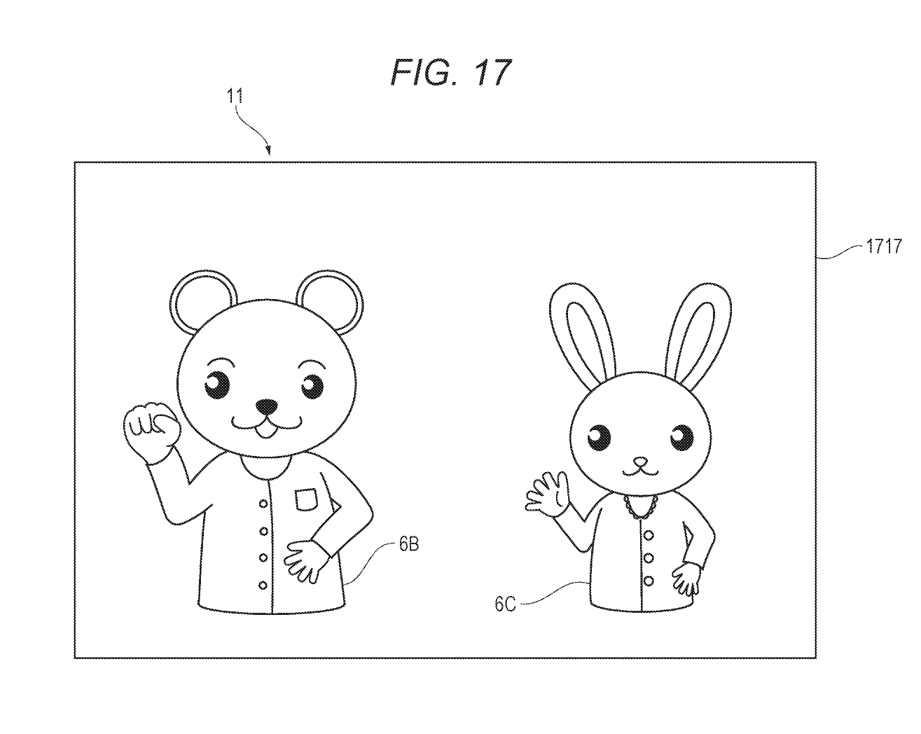

The visual field of the avatar object 6A matches the visual the hips of the virtual camera 14 in the HMD set 110A. As a result, the field-of-view image 17 in a first-person perspective of the avatar object 6A is provided to the user 5A. More specifically, a virtual experience as if the user 5A were present as the avatar object 6A in the virtual space 11 is provided to the user 5A. FIG. 17 is a diagram for illustrating a field-of-view image 1717 to be provided to the user 5A via the HMD 120A. A field-of-view image in a first-person perspective of each of the avatar objects 6B and 6C is similarly provided to each of the users 5B and 5C.

The motion information included in the avatar information described with reference to FIG. 13 includes, for example, information indicating a temporal change in the position and inclination of the HMD 120A detected by the HMD sensor 410 and the like, and information indicating the motion of the hands of the user 5A detected by the motion sensor 420 and the like.

The avatar information includes information designating a movement destination of the avatar object 6A in accordance with an operation by the user 5A or the line of sight of the user 5A, and information indicating the target object or the avatar object being looked at by the user 5A (information enabling line-of-sight target to be identified). Information indicating the movement destination is information designated by the controller 300 or based on the line-of-sight direction. For the target object or the like being looked at by the user 5A, the target object or the character player in the line-of-sight direction is determined in accordance with a collision determination based on the line of sight of the user 5A. The avatar information may include, in place of the information indicating the target object or the avatar object, the line-of-sight direction of the user 5A with respect to a reference line in the virtual space. In this case, the target object and the character player are determined on the receiving side (in this example, HMD set 110B or the like) based on a collision determination.

In Step S1330A described with reference to FIG. 13, when the user 5A has designated the movement destination by using the controller 300 (Step S1310A), the processor 210 of the HMD set 110A serves as the virtual camera control module 1421 to move the virtual camera 14 to the movement destination. Then, the processor 210 serves as the virtual object control module 1425 to determine a movement path and a movement mode of the avatar object 6A based on a movement start point (current position in virtual space of avatar object 6A), the movement destination, the environment of the virtual space, and an attribute of a target object around the avatar object 6A (target object arranged between the movement start point and movement destination).

For example, when a table and chairs are arranged as the target objects to be arranged from the movement start point to the movement destination of the avatar object 6A or the like (i.e., when the environment is a so-called conference room), the processor 210 serves as the virtual object control module 1425 to determine a movement path in which the avatar object 6A avoids the table and chairs. The processor 210 also determines such a movement mode that the avatar object 6A stands up from a state of sitting on a chair, walks to the movement destination, and sits on a chair. The environment or attribute of the target object, the corresponding movement mode, and the algorithm for determining the movement path are information stored in advance in the object information 242. The processor 210 determines the movement mode and the movement path based on that information.

The processor 210 serves as the field-of-view image generating module 1429 to generate a field-of-view image showing how the avatar object 6A is to move from the movement start point to the movement destination based on the determined movement path and movement mode.

The processor 210 serves as the field-of-view image generating module 1429 to further update the information (directions of line of sight and face) on the avatar object 6A such that the avatar object 6A is looking at the avatar object 6B and the avatar object 6C determined based on the line-of-sight direction of the user 5A. The processor 210 similarly updates the information on the avatar objects 6B and 6C.

In this disclosure, when the user 5A receives the designation of the movement destination of the avatar object 6A, the processor 210 serves as the virtual camera control module 1421 to instantaneously move the virtual camera 14 to the movement destination without generating a field-of-view image indicating the movement process of the avatar object 6A to the movement destination. In the virtual space, the reference direction is defined at the position of the movement destination in some cases, and the avatar object 6A, namely, the virtual camera 14, is controlled to automatically face the reference direction. From the perspective of preventing VR sickness, when the designation of the movement destination is received, during the transition period in which the virtual camera is moving from the movement start point of the avatar object 6A to the movement destination, it is preferred that generation of at least a part of the field-of-view image corresponding to that transition period be omitted to generate a field-of-view image from the movement destination. For example, in place of instantaneously moving the avatar object 6A from the movement start point to the movement destination, the avatar object 6A may gradually start to move in a smooth manner, then after the avatar object 6A has moved close to the movement destination, the movement to the movement destination is completed by again gradually moving the avatar object 6A in a smooth manner. In this case, not all of the visual-field images but a part of the visual-field images is generated during the transition period in which the avatar object 6A or the virtual camera is moving from the movement start point to the movement destination. It is also possible to generate all of the visual-field images during the transition period, but display only a part of the visual-field images on a display of the HMD during the transition period. Specifically, it is only required to prevent the user 5A from recognizing at least a part of the visual-field images during the transition period. In the following embodiment, there is described a mode in which the avatar object 6A or the virtual camera 14 instantaneously moves to the movement destination.

Then, the processor 210 serves as the field-of-view image generating module 1429 to generate a field-of-view image as viewed from the movement destination showing how the avatar object 6A is to move from the movement start point to the movement destination.

As a result, the user 5A does not move in synchronization with the motion of the HMD set 110A, and hence it is possible to prevent the user 5A from suffering VR sickness.

In Step S1330B, when the communication control module 540 of the HMD set 110B receives the movement destination of the avatar object 6A via the server 600, the processor 210 serves as the virtual object control module 1425 to determine the movement path and the movement mode based on the movement start point, the movement destination, and the environment of the virtual space or the attribute of the target object. Then, the processor 210 of the HMD set 110B serves as the virtual object control module 1425 to control the motion of the avatar object 6A based on the determined movement path and movement mode.

At this time, the processor 210 serves as the virtual object control module 1425 to adjust the face direction and the line of sight of the avatar object 6A such that the avatar object 6A looks at the target object or the avatar object actually being looked at by the user 5A. For example, the processor 210 serves as the virtual object control module 1425 to grasp the position in the virtual space of the information indicating the target object or the avatar object determined based on the line-of-sight direction of the user 5A included in the motion information, and performs control so that the avatar object 6A faces the direction of that position while walking.

The movement mode is not limited to realistic movements. Any movement mode can be employed as long as the movement start point and the movement destination can be distinguished from each other, and the movement has continuity and relevancy. For example, in an environment in which the avatar object 6A is in a hilly area, a movement mode and movement path in which the avatar object 6A moves along tree branches may be determined. A movement mode in which the avatar object 6A flies through the sky or gets on a vehicle such as an automobile, a bicycle, or an electric two-wheeled vehicle that is ridden standing upright may also be employed. A movement mode and a movement path in which the avatar object 6A changes into a beam of light like a wizard and flies from the movement start point to the movement destination may also be determined. The avatar object 6A may also move by appearing in a virtual space in which the ends of a clay pipe or a tunnel serve as entrances and exits. In that case, processing may be carried out that causes the avatar object to look as if the avatar object were diving into the clay pipe or tunnel, and to shine when the avatar object comes out.

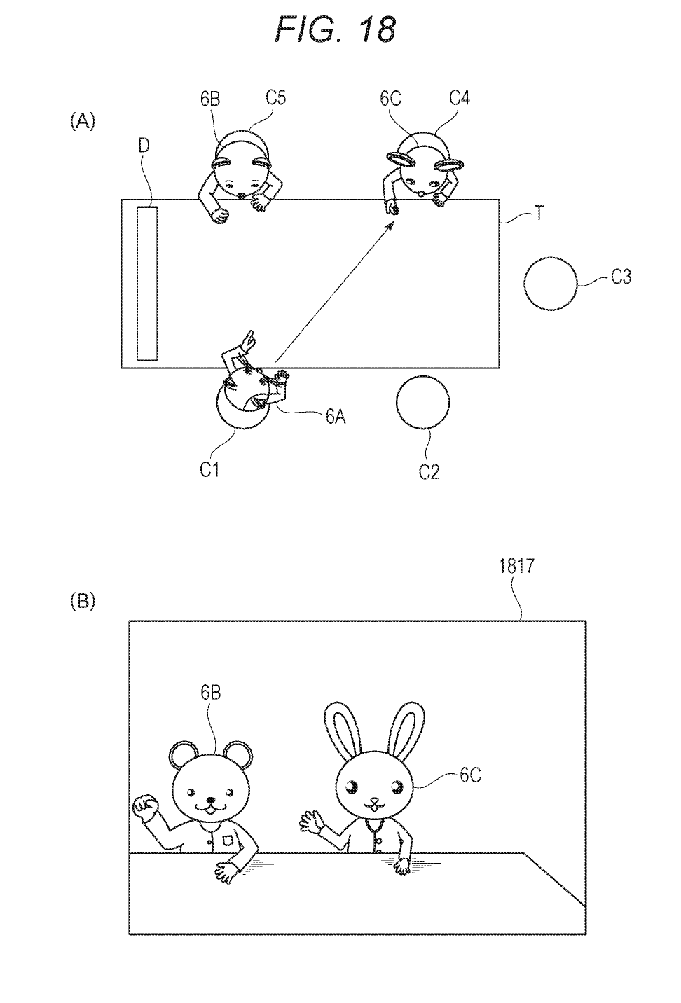

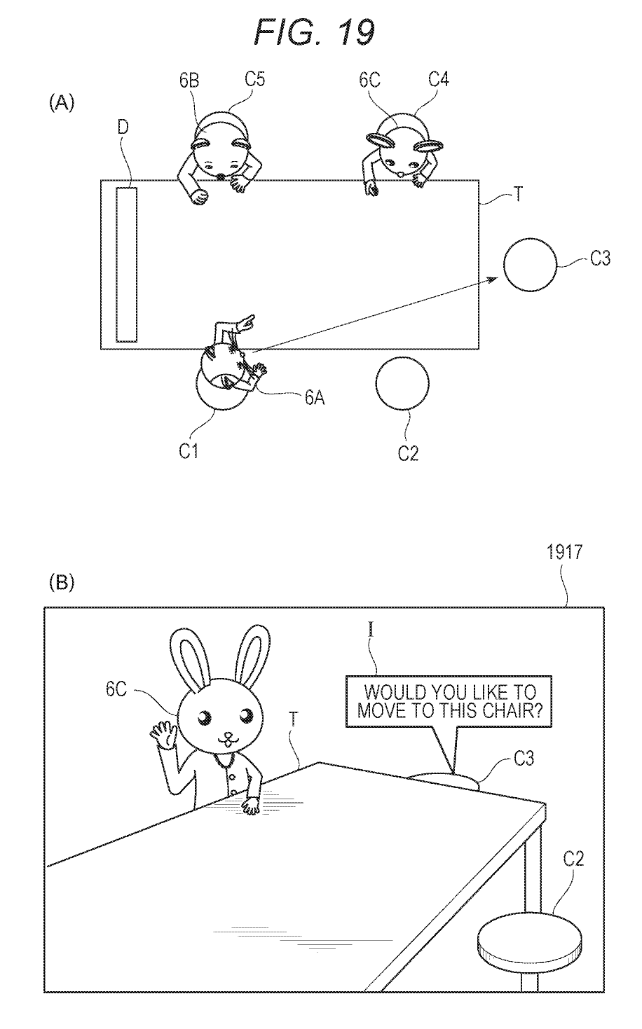

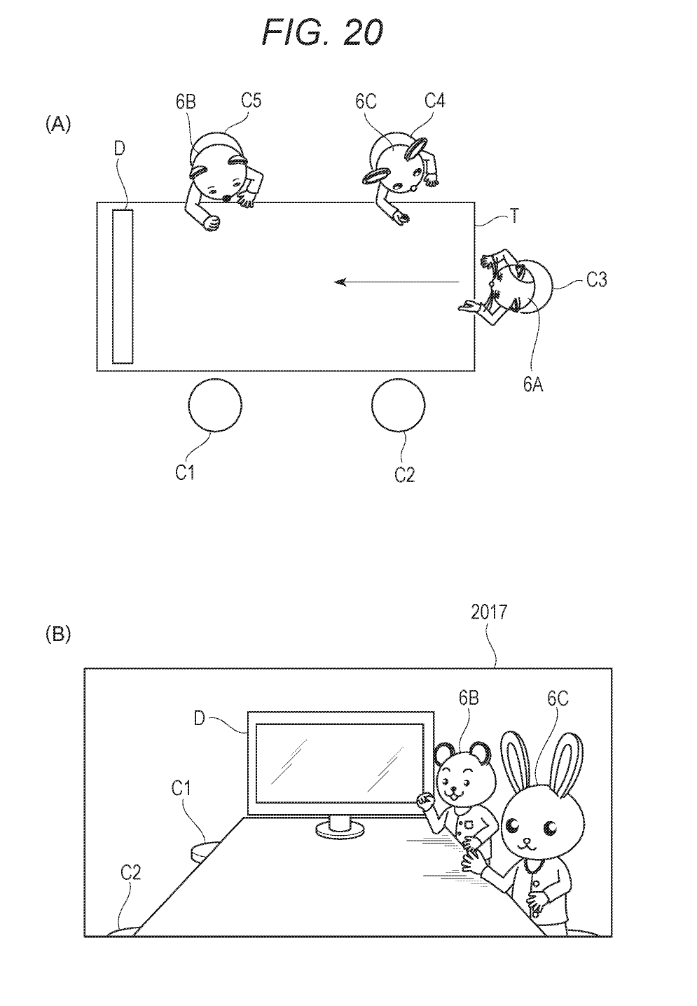

Next, the position and the movement of each avatar object 6A to 6C in the virtual space are described by way of specific examples. FIG. 18A, FIG. 19A, and FIG. 20A are each a diagram for schematically illustrating the positional relationship among the avatar objects at the time when the avatar object 6A moves from the movement start point to the movement destination, and FIG. 18B, FIG. 19B, and FIG. 20B are each a diagram for illustrating the corresponding field-of-view image of the avatar object 6A. In each of FIG. 18A to FIG. 20B, a table T and chairs C1 to C5 surrounding the table T are illustrated, and the avatar objects 6A to 6C are present there.

In FIG. 18A, there is illustrated a state in which the avatar object 6A is sitting on the chair C1 and looking at the avatar object 6B. In FIG. 18B, there is illustrated a field-of-view image 1817 of the avatar object 6A. In FIG. 18A, the avatar object 6A is looking at the avatar object 6B. Therefore, as illustrated in FIG. 18B, the avatar object 6B is arranged in the center of the field-of-view image 1817 of the avatar object 6A.

Then, as illustrated in FIG. 19A, the user 5A designates the movement destination by looking at the chair C3 and operating the controller 300. In FIG. 19B, there is illustrated a field-of-view image 1917 of the avatar object 6A at that time. As illustrated in FIG. 19B, the processor 210 serves as the field-of-view image generating module 1429 to generate the field-of-view image 1917 including a message I “Would you like to move to this chair?” based on an operation by the user 5A.

FIG. 20A is a diagram for illustrating that the avatar object 6A has moved to the chair C3. When the user 5A designates the movement destination, the processor 210 serves as the field-of-view image generating module 1429 to generate a field-of-view image 2017 as viewed from the movement destination of the avatar object 6A. The reference direction at each position is defined. In this disclosure, the direction facing the table is defined as the reference direction at each position. Therefore, the avatar object 6A is controlled so as to automatically face the reference direction when moving to the movement destination, and the field-of-view image 2017 based on that direction is generated.

In this way, the avatar object 6A instantaneously moves from the movement start point to the movement destination in accordance with the designation of the movement destination. As a result, the HMD set 110 does not provide a field-of-view image that is not synchronized with the motion of the HMD set 110, for example, a field-of-view image from the avatar object 6A during the movement process, and hence so-called VR sickness can be prevented.

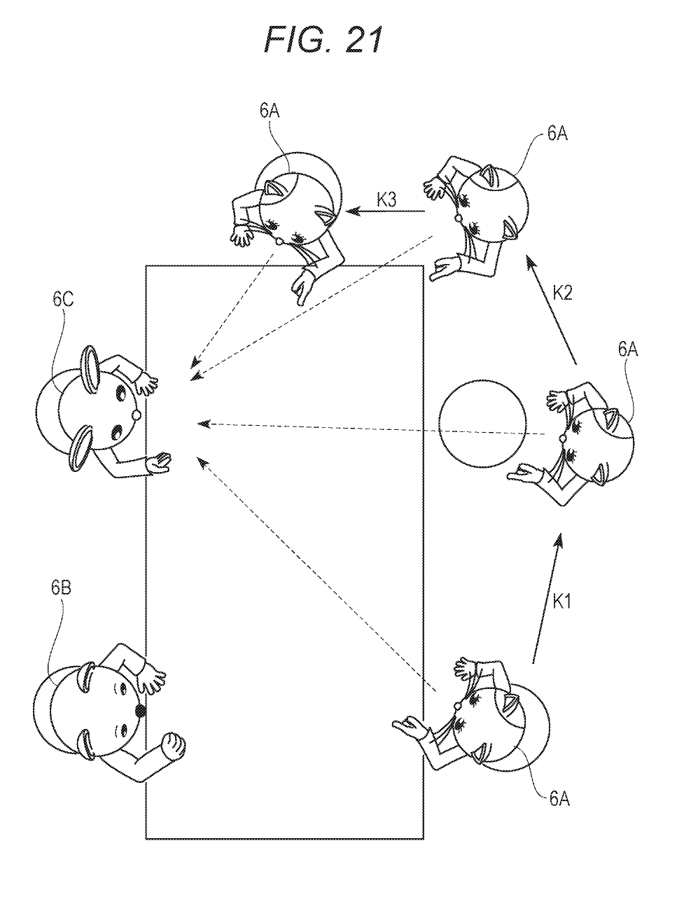

As described above, the processor 210 provides the field-of-view image to be provided to the user 5A such that the avatar object 6A (virtual camera 14) instantaneously moves from the movement start point to the movement destination in response to the designation of the movement destination. Meanwhile, in each of the HMD sets 110B and 110C of the other users (avatar objects 6B and 6C), a field-of-view image is generated in which the avatar object 6A moves in accordance with the determined movement path and movement mode from the movement start point to the movement destination. FIG. 21 is a diagram for schematically illustrating a movement path in which the avatar object 6A moves from a movement start point to a movement destination. As illustrated in FIG. 21, the avatar object 6A moves via movement paths K1 to K3 determined by the processor 210. The movement paths K1 and K2 are paths determined such that the chairs are avoided. The movement path K3 is a path for the avatar object 6A to sit on the chair at the movement start point. The processor 210 serves as the virtual object control module 1425 to control, based on the attribute of the target object, namely, the chairs, such that the avatar object 6A performs motion in which the avatar object 6A avoids the chairs and then sits on a chair.

As described above, the avatar object 6A is chatting with the avatar object 6C, and the user 5A is looking at the avatar object 6C at that time. Information indicating the avatar object 6C (line-of-sight target) is transmitted to the server 600 as avatar information. Therefore, control in which the avatar object 6A is moved to the movement destination while looking at the avatar object 6C is performed in each of the HMD sets 110B and 110C. Similarly, the user 5C is looking at the moving avatar object 6A, and hence the avatar information indicating the fact is transmitted to the server 600, and control in which the avatar object 6C looks at the avatar object 6A is performed.

In general, each HMD set 110 controls the avatar objects 6 in the virtual space 11 in synchronization with the motion of the HMD 120. In this disclosure, in a predetermined state, for example, while the avatar objects 6 are moving, the control of the avatar objects 6 is performed in a mode that is not in synchronization with the motion of the HMDs 120, even while performing the control of the avatar objects 6 in the manner described above based on the line of sight and the like. As a result, the avatar objects 6 can look as though the avatar objects 6 are acting natural even when the avatar objects 6 are chatting while moving.

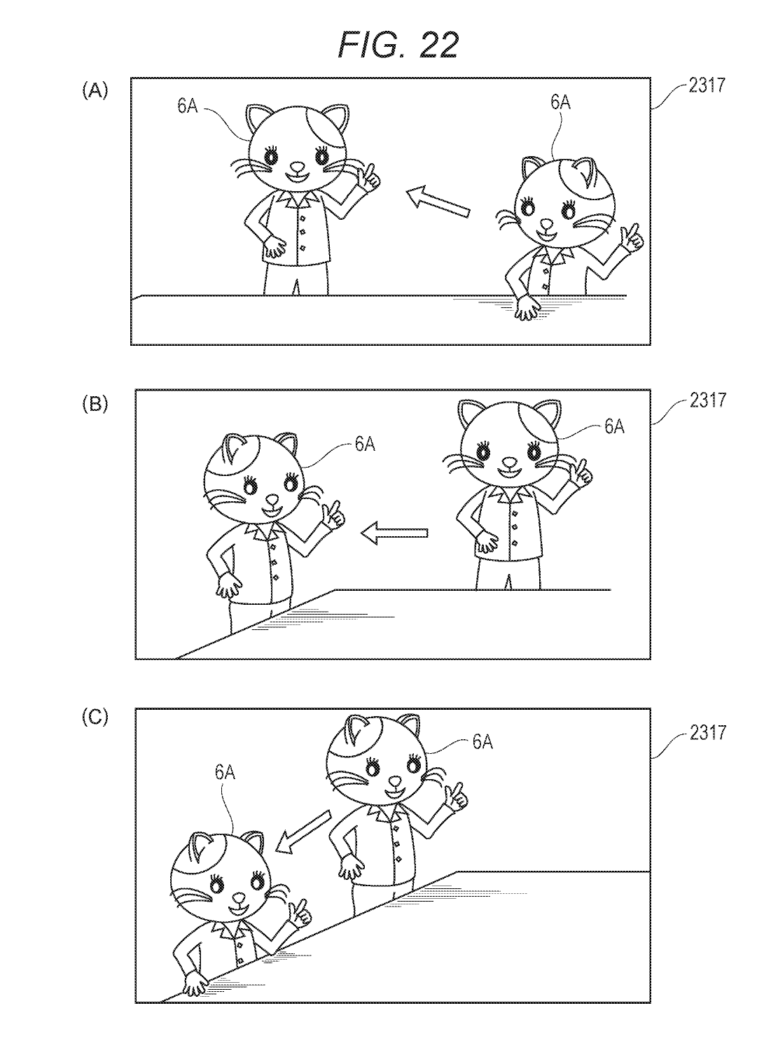

FIG. 22A to FIG. 22C are diagrams for illustrating a specific example of the field-of-view image generated by the HMD set 110C worn by the user 5C.

In FIG. 22A, there is illustrated a field-of-view image 2317 to be provided to the user 5C (avatar object 6C), in which the avatar object 6A stands up from the movement start point and moves in accordance with the movement path and the movement mode. As illustrated in FIG. 22A, the line of sight of the avatar object 6A is directed in the direction of the avatar object 6C, and the avatar object 6A and the avatar object 6C are in eye contact with each other. Even when the avatar object 6A instantaneously moves to the movement destination, the processor 210 of the HMD set 110C can generate the field-of-view image 2317 based on the acquired movement start point and movement destination of the avatar object 6A. As a result, the user 5C can receive a field-of-view image in which the avatar object 6A is walking in front of the user 5C. When the processor 210 of the HMD set 110C receives information enabling the avatar object 6C to be identified as the line-of-sight target from the HMD set 110A, the processor 210 of the HMD set 110C can determine that the avatar object 6A is looking at the avatar object 6C. Then, the processor 210 expresses the field-of-view image 2317 such that the avatar object 6A faces the avatar object 6C, which enables the user 5A and the user 5C to chat in a natural manner.

In this disclosure, when moving, the avatar object 6 always faces the line-of-sight target being looked at by the user 5. However, this disclosure is not limited to that. For example, control can be performed such that the avatar object 6A faces the avatar object 6C only when a bidirectional condition that the avatar object 6A and the avatar object 6C are looking at each other is established. When the bidirectional condition is not established, the direction the avatar object 6A faces may be set as the travel direction. The bidirectional condition may be, for example, that the line-of-sight target of the user 5A matches the line-of-sight target of the user 5C. More specifically, determination of the bidirectional condition is implemented by the HMD set 110A of the user 5A receiving information on the line-of-sight target the user 5C is looking at, and comparing the line-of-sight target the user 5A is looking at and the received line-of-sight target. As a matter of course, that processing can also be applied to the HMD sets 110B and 110C.

In FIG. 22B, there is illustrated a field-of-view image 2217 to be provided to the user 5C showing a state in which the avatar object 6A is moving along the movement path K2. Similarly to FIG. 22A, the line of sight of the avatar object 6A is directed at the avatar object 6C.

In FIG. 22C, there is illustrated a field-of-view image 2217 to be provided to the user 5C showing a state in which the avatar object 6A is moving along the movement path K3. Similarly to FIG. 22A and FIG. 22B, the line of sight of the avatar object 6A is directed at the avatar object 6B. There is a chair at that movement destination, and hence the avatar object 6A performs motion of sitting on the chair.

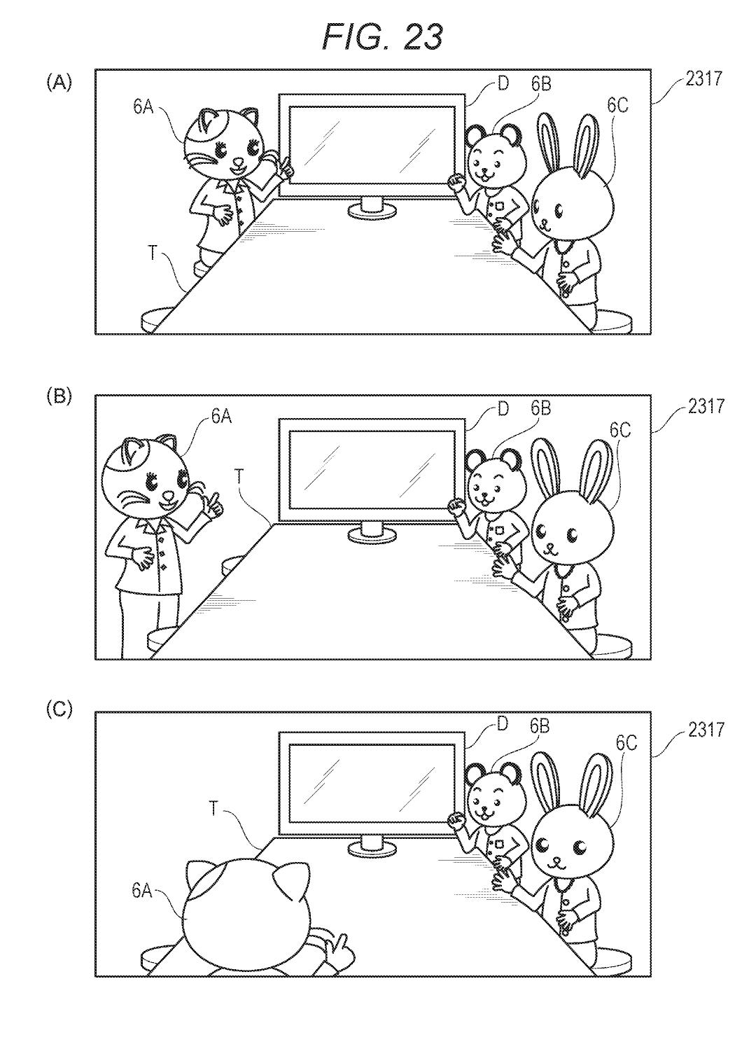

Next, with reference to FIG. 23A to FIG. 23C, there is described a field-of-view image 2317 to be provided to the user 5A showing how the avatar object 6A is to move from the movement destination of the avatar object 6A. In FIG. 23A, there is illustrated the field-of-view image 2317 to be provided to the user 5A as viewed when the user 5A, who is at the movement start point, sees himself or herself (avatar object 6A) from the movement destination. The processor 210 of the HMD system 100A serves as the field-of-view image generating module 1429 to generate the field-of-view image 2317 illustrated in FIG. 23A when the user 5A designates a movement destination by a predetermined operation. At that time, the user 5A is looking at the avatar object 6B, and hence the line of sight of the avatar object 6A is directed in the direction of the avatar object 6B. The user 5C is looking at the avatar object 6A, and hence the avatar object 6C operated by the user 5C is facing the direction of the avatar object 6A.

In FIG. 23B, there is illustrated the field-of-view image 2317 to be provided to the user 5A showing how the avatar object 6A is moving as viewed by the user 5A from the movement destination. Similarly to FIG. 23A, the avatar object 6A and the avatar object 6B are controlled so as to face each other. When the user 5A or the user 5B looks in a different direction, the avatar objects 6A and 6B also face the target object that the user 5A or the user 5B is looking at.

In FIG. 23C, there is illustrated the field-of-view image 2317 to be provided to the user 5A when the avatar object 6A has reached the movement destination and is about to sit on a chair. After displaying the field-of-view image illustrated in FIG. 23C, the processor 210 of the HMD set 110A stops the rendering processing of the avatar object 6A, and generates a normal field-of-view image without displaying the own avatar object 6A operated by the user 5A.

In this way, the avatar objects 6A and 6C can be controlled so as to face each other, which enables the users 5A and 5C to recognize that the other party is looking at him or her, and as a result, the users 5A and 5C can enjoy chatting in a natural manner. The user 5B does not participate in this chat, but he or she is watching and listening to the chat. Therefore, the user 5B is provided with a field-of-view image that enables the user 5B to recognize that the avatar object 6A and the avatar object 6C chatting in the same manner as described above.

It is expected that the user 5A may look at his or her own avatar object 6A rather than the avatar object 6C that is his or her chat partner. In such a case, when the processor 210 of the HMD set 110A of this disclosure can determine, as the virtual object control module 1425, that the user 5A has looked at his or her own avatar object 6A, the processor 210 of the HMD set 110A may perform control such that the user 5A continues to look at the avatar object that he or she was looking at immediately prior to that, or may perform control such that the user 5A faces the front of the avatar object 6A. This enables the avatar object to behave in a natural manner.

In FIG. 23A to FIG. 23C, there is illustrated the field-of-view image 2317 of the user 5A from the movement destination of the avatar object 6A, but the field-of-view image 2317 is not limited thereto. For example, when the user 5A designates the movement destination, the processor 210 of the HMD set 110 may serve as the virtual camera control module 1421 to move the virtual camera 14 to an overhead view position determined in advance, and provide to the user 5A a field-of-view image M from that position. The overhead view position may be, for example, a position from which both the movement start point and the movement destination can be viewed, but it is sufficient if the overhead view position is a position from which the movement path along which the avatar object 6A is to move from the movement start point to the movement destination can be expressed.

In the embodiment described above, the description is given by exemplifying the virtual space (VR space) in which the user is immersed using an HMD. However, in at least one embodiment, a see-through HMD is adopted as the HMD. In this case, in at least one embodiment, the user is provided with a virtual experience in an augmented reality (AR) space or a mixed reality (MR) space through output of a field-of-view image that is a combination of the real space recognized by the user via the see-through HMD and a part of an image forming the virtual space. In this case, in at least one embodiment, action is exerted on a target object in the virtual space based on motion of a hand of the user instead of the operation object. Specifically, in at least one embodiment, the processor identifies coordinate information on the position of the hand of the user in the real space, and defines the position of the target object in the virtual space in connection with the coordinate information in the real space. With this, the processor is able to grasp a positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

The subject matters disclosed herein are now described as, for example, the following items.

(Item 1)

An information processing method to be executed on a computer (HMD set 110C), in which, in a virtual space including a first character object (avatar object 6A) associated with a first user (user 5A) and a second character object (avatar object 6C) associated with a second user (user 5C), a virtual camera 14 for defining a field-of-view image from the second character object is controlled, and the field-of-view image from the virtual camera 14 is provided to the second user via a head-mounted display (HMD 120C), the information processing method including the steps of:

acquiring information designating a movement destination of the first character object (Step S1330C of FIG. 13);

identifying a movement guidance line in the virtual space based on a movement start point and the movement destination of the first character object (Step S1330C of FIG. 13); and

generating the field-of-view image including the first character object moving based on the movement guidance line, and presenting the generated field-of-view image on the head-mounted display (Step S1330C of FIG. 13, and Step S1570 and Step S1572 of FIG. 15).

In the information processing method of this item, the second user is provided with a field-of-view image in which the first character object, for example, the avatar object, of the first user moves in accordance with the movement guidance line identified based on the movement start point and the movement destination of the first character object. As a result, for the second user, who is provided with a virtual space service in which control is performed to instantaneously move the first character object of the first user from the movement start point to the movement destination, unnatural motion of the first character object of the first user can be eliminated, and hence the sense of immersion in the virtual space can be increased.

For example, in order to prevent VR sickness by the first user, there can be provided a virtual space service in which a field-of-view image of the movement destination is instantaneously provided without providing a field-of-view image showing the movement. Under normal control, it appears to the second user that the first character object of the first user instantaneously moves from the movement start point to the movement destination. However, such unnatural motion impairs the sense of immersion in the virtual space. Therefore, even when the first character object of the first user instantaneously moves from the movement start point to the movement destination, for the second user, who is looking at the first character object, his or her sense of immersion in the virtual space can be increased by providing a field-of-view image in which the first character object appears to be moving naturally.

The service is not limited to the above-mentioned service. For example, movement control of the first character object can be easily performed on the second user side without acquiring from the first user information for performing the movement control of the first character object, by performing the movement control based on the movement start point and the movement destination of the first character object on the second user side.

(Item 2)

An information processing method according to Item 1, wherein the movement guidance line is shown in a mode enabling the movement start point and the movement destination to be distinguished.

In the information processing method of this item, through distinguishing of the movement start point and the movement destination of the first character object, the second user can grasp from where to where the first character object is to move, which enables a more sophisticated virtual experience to be provided.

(Item 3)

An information processing method according to Item 1 or 2,

wherein the step of acquiring information includes acquiring information enabling identification of a line-of-sight target that the first user is looking at and that is identified based on a line of sight of the first user, and

the step of presenting the generated field-of-view image includes generating the field-of-view in which the first character object faces the line-of-sight target based on the information enabling identification of the line-of-sight target.

In the information processing method of this item, the information enabling identification of the line-of-sight target that the first user is looking at is acquired based on the line of sight of the first user, and the field-of-view image in which the first character object faces the line-of-sight target is generated based on the information enabling identification of the line-of-sight target. As a result, what the first user is looking at can be matched with what the first character object is looking at, which enables a more sophisticated virtual experience to be provided to the second user.

(Item 4)

An information processing method according to any one of Items 1 to 3, further including a step of determining a moving guidance line or a movement mode based on an attribute of an object to be arranged between the movement start point and the movement destination,

wherein the step of presenting the generated field-of-view image includes generating the field-of-view image in which the first character object moves in accordance with the movement guidance line or the movement mode.

In the information processing method of this item, through generation of the field-of-view image in which the first character object moves in accordance with the movement guidance line or the movement mode based on the attribute of the object to be arranged between the movement start point and the movement destination, the first character object can move in a more realistic manner. As a result, a more sophisticated virtual experience can be provided to the second user.

(Item 5)

An information processing system for defining a virtual space including a first character object associated with a first user and a second character object associated with a second user, the information processing system including:

a first information processing apparatus configured to control a virtual camera configured to define a first field-of-view image from the first character object based on motion of a first head-mounted display, and to provide the first field-of-view image to the first user; and

a second information processing apparatus configured to control a virtual camera configured to define a second field-of-view image from the second character object based on motion of a second head-mounted display, and to provide the second field-of-view image to the second user,

the first information processing apparatus being configured to execute the steps of:
receiving a movement destination of the first character object in the virtual space; and
omitting, when the movement destination is received, generation of at least a part of the first field-of-view images corresponding to a transition period in which the virtual camera moves from a movement start point of the first character object to the movement destination, and presenting on the first head-mounted display the first field-of-view image from the movement destination,

the second information processing apparatus being configured to execute the steps of:
acquiring information designating the movement destination of the first character object;
identifying a movement guidance line in the virtual space based on the movement start point and the movement destination of the first character object; and
presenting on the second head-mounted display the second field-of-view image including the first character object that moves based on the movement guidance line.

(Item 6)

A program for executing the information processing method of any one of Items 1 to 4 on a computer.

(Item 7)

An apparatus, including:

a memory having the program of Item 6 stored thereon; and

a processor, which is coupled to the memory, and is configured to execute the program.

1. A method, comprising:
defining a virtual space, the virtual space including a first object associated with a first user, a second object associated with a second user, and a virtual viewpoint associated with the second object;
identifying a position of the virtual viewpoint and, in accordance with motion of a head-mounted device (HMD) associated with the second user, a field of view in the virtual space;
displaying on the HMD a field-of-view image corresponding to the field of view;
identifying a first position at which the first object is arranged in the virtual space;
acquiring information designating a second position, the second position being a position of a movement destination of the first object in the virtual space;
identifying a guidance line from the first position toward the second position;
moving the first object along the guidance line from the first position to the second position;
displaying on the HMD the visual-field image including an animation representing that the first object is moving;
identifying a third position at which the second object is arranged in the virtual space;
acquiring information designating a fourth position, the fourth position being a position of a movement destination of the second object in the virtual space;
moving the position of the virtual viewpoint from the third position to an observation position associated with the fourth position; and
generating the field-of-view image during a transition period in which the position of the virtual viewpoint is moving, at least a part of the field-of-view images to be generated during a process of moving from the third position to the observation position being omitted.

2. A method according to claim 1, wherein the moving the first object along the guidance line includes presenting, on the guidance line, the first position in a first mode and the second position in a second mode different from the first mode.

3. A method according to claim 1, further comprising:
identifying, when acquiring the second position, a direction of a line of sight of the first user in the virtual space;
identifying a target at which the line of sight of the first user is directed; and
moving, in a state in which the line of sight is directed at the target, the first object from the first position to the second position.

4. A method according to claim 1,
wherein the virtual space includes a third object, and
wherein the method further comprises changing a path of the guidance line in response to the third object being arranged on the guidance line.

5. A method according to claim 1,
wherein the virtual space includes a third object, and
wherein the method further comprises changing a mode of the animation in response to the third object being arranged on the guidance line.

6. A method according to claim 1, further comprising:
identifying a direction of a line of sight of the first user in the virtual space;
identifying a target at which the line of sight of the first user is directed; and
controlling the first object so that the line of sight of the first object is directed at the target.

7. A method according to claim 6, further comprising:
detecting that the target is the second object; and
controlling, in response to the position of the virtual viewpoint having moved to the observation position, the first object such that the line of sight of the first object is directed at the virtual viewpoint.

8. A method according to claim 1, further comprising:
identifying a direction of a line of sight of the first user in the virtual space;
identifying a target at which the line of sight of the first user is directed; and
moving, in a state in which the line of sight is directed at the target, the first object from the first position to the second position.

9. A method, comprising:
defining a virtual space, the virtual space including a virtual viewpoint and a first object associated with a first user;
identifying a position of the virtual viewpoint and, in accordance with motion of a head-mounted device (HMD) associated with the first user, a field of view in the virtual space;
displaying on the HMD a field-of-view image corresponding to the field of view;
identifying a first position at which the first object is arranged in the virtual space;
acquiring information designating a second position, the second position being a position of a movement destination of the first object in the virtual space;
moving the position of the virtual viewpoint from the first position to an observation position associated with the second position;
generating the field-of-view image during a transition period in which the position of the virtual viewpoint is moving, at least a part of the field-of-view images to be generated during a process of moving from the first position to the observation position being omitted; and
displaying how the first object moves from the first position to the second position in the field of view from the virtual viewpoint arranged at the observation position.

10. A method according to claim 9,
wherein the observation position includes the second position, and
wherein the field of view includes a first-person view of the first object after the first object has moved to the second position.

11. A method according to claim 9,
wherein the observation position includes a position enabling a field-of-view image including the second position to be generated, and
wherein the field of view includes a third-person view of the first object after the first object has moved to the second position.

12. A method according to claim 9, further comprising:
identifying, when acquiring the second position, a direction of a line of sight of the first user in the virtual space;
identifying a target at which the line of sight of the first user is directed; and
moving, in a state in which the line of sight is directed at the target, the first object from the first position to the second position.

13. A method according to claim 9,
wherein the virtual space includes a second object associated with a second user different from the first user, and
wherein the method further comprises:
identifying a direction of a line of sight of the second user in the virtual space;
identifying a target at which the line of sight of the second user is directed; and
moving, in a state in which the line of sight is directed at the target, the first object from the first position to the second position.
